(19) United States
(12) Patent Application Publication
(10) Pub. No.: US 2020/0288361 A1
(43) Pub. Date: Sep. 10, 2020

(54) WIRELESS COMMUNICATION SYSTEM, WIRELESS TERMINAL, AND WIRELESSCOMMUNICATION METHO

(71) Applicant: RENESAS ELECTRONICS CORPORATION, Tokyo (JP)

(72) Inventors: Kazuhisa OKADA, Tokyo (JP); Hiroki SUGIMOTO, Tokyo (JP)

(21) Appl. No.: 16/806,789

(22) Filed: Mar. 2, 2020

(30) Foreign Application Priority Data
Mar. 5, 2019 (JP) 2019-039227

(51) Int. Cl. H04W 36/00; H04W 52/02; H04W 36/38

(52) U.S. Cl. CPC H04W 36/03; H04W 52/0261; H04W 88/06; H04W 36/385; H04W 52/0212

(57) ABSTRACT

A wireless communication system includes a wireless base station, a plurality of wireless terminals that communicate with the wireless base station using a first communication function, communicate with each other using a second communication function that consumes less power than the first communication function, and are driven by a battery, and a wireless controller. According to the configuration, it is possible to solve problems of the battery replacement cost of the wireless terminals in the system.

### CROSS-REFERENCE TO RELATED APPLICATIONS

The disclosure of Japanese Patent Application No. 2019-039227 filed on Mar. 5, 2019 including the specification, drawings and abstract is incorporated herein by reference in its entirety.

### BACKGROUND

The present invention relates to a wireless communication system, and can be suitably applied to, for example, a wireless communication system including a plurality of wireless terminals driven by a battery.

In recent years, the LPWA (Low Power Wide Area) communication system has been rapidly spreading. The LPWA communication system is characterized by a low bit rate and long communication distances, but the power consumed by the wireless terminal increases because the communication duration increases. Therefore, when a battery-driven wireless terminal performs communication over networks using the LPWA communication system, the battery is consumed more, and the battery remaining time indicating the remaining time that can be driven by the battery is shortened.

U.S. Pat. No. 9,438,311 discloses a communication process for battery-powered wireless terminals in environmentals where a low power network with low power consumption and a high power network with high power consumption exist.

### SUMMARY

However, in the related art, a clear algorithm for the determination is not described. Thus, a particular wireless terminal may continue the bridge terminal. As a result, the wireless terminal continuing the bridge terminal consumes more batteries than the other wireless terminals, so that the battery remaining time becomes shorter and the battery replacement time becomes earlier. As a result, variations occur in the battery replacement timing among the wireless terminals in the system, and the battery replacement cost of the wireless terminals in the system as a whole becomes high.

In recent years, in networks using a LPWA communication system, as communication distances are increased, the installation locations of terminals are widened, and the reduction of the battery replacement costs of wireless terminals becomes a significant problem due to the increase in the frequency of maintenance work for battery replacement of wireless terminals.

Other objects and novel features will become apparent from the description of this specification and the accompanying drawings.

According to one embodiment, a wireless communication system includes a wireless base station, a plurality of wireless terminals that communicate with the wireless base station using a first communication function, communicate with each other using a second communication function that consumes less power than the first communication function, and are driven by a battery, and a wireless controller. Based on the battery information of each of the plurality of wireless terminals, when there is a wireless terminal having a short battery remaining time, the wireless control device selects the wireless terminal as the first wireless terminal, and when the first wireless terminal is selected, the wireless control device selects the wireless terminal having a long battery remaining time as the second wireless terminal. Then, the wireless control device instructs the wireless base station and the first and second wireless terminals to change the communication path between the first wireless terminal and the wireless base station to a communication path communicating between the first wireless terminal and the wireless base station via the second wireless terminal, and to connect the first wireless terminal and the second wireless terminal by the second communication function. After receiving this instruction, the first wireless terminal transmits uplink data including at least one of battery information and communication data transmitted from the first wireless terminal to the wireless base station to the second wireless terminal using the second communication function, and the second wireless terminal transmits the uplink data to the wireless base station using the first communication function.

In addition, the second wireless terminal receives downlink data including communication data, which is transmitted from the wireless base station to the first wireless terminal, from the wireless base station using the first communication function, and transmits the downlink data to the first wireless terminal using the second communication function.

According to the above-mentioned embodiment, it is possible to contribute to the solution of the above-mentioned problem of the battery replacement cost of the wireless terminals in the system.

### BRIEF DESCRIPTION OF THE DRAWINGS

FIG. 1 is a diagram illustrating a configuration example of a wireless communication system according to a first embodiment.

FIG. 2 is a block diagram showing a configuration example of a wireless terminal according to the first embodiment.

FIG. 3 is a diagram showing examples of specifications of wide area wireless communication using a LoRa modulation method and short-range wireless communication using a (G)FSK modulation method as an example of a LPWA communication method.

FIG. 4 is a flowchart illustrating an example of a procedure for changing a wireless connection of a wireless terminal having a short battery remaining time in the first embodiment.

FIG. 5 is a diagram illustrating an example of a procedure for changing a wireless connection of a wireless terminal having a short battery remaining time in the first embodiment.

FIG. 6 is a diagram illustrating an example of a procedure for changing a wireless connection of a wireless terminal having a short battery remaining time in the first embodiment.

FIG. 7 is a diagram illustrating an example of a procedure for changing a wireless connection of a wireless terminal having a short battery remaining time in the first embodiment.

FIG. 8 is a diagram illustrating an example of a procedure for changing a wireless connection of a wireless terminal having a short battery remaining time in the first embodiment.

FIG. 9 is a diagram illustrating an example of a procedure for changing a wireless connection of a wireless terminal having a short battery remaining time in the first embodiment.

FIG. 10 is a diagram illustrating an example of a procedure for changing a wireless connection of a wireless terminal having a short battery remaining time in the first embodiment.

FIG. 11 is a flowchart illustrating another example of a procedure for changing a wireless connection of a wireless terminal having a short battery remaining time in the first embodiment.

FIG. 12 is a diagram illustrating another example of a procedure for changing a wireless connection of a wireless terminal having a short battery remaining time in the first embodiment.

FIG. 13 is a diagram illustrating an example of a method in which a wireless control device grasps, for each of a plurality of wireless terminals, a wireless terminal capable of short-range wireless connection with the wireless terminal in the first embodiment.

FIG. 14 is a diagram illustrating an example of a method in which a wireless control device grasps, for each of a plurality of wireless terminals, a wireless terminal capable of short-range wireless connection with the wireless terminal in the first embodiment.

FIG. 15 is a diagram illustrating an example of a method in which a wireless control device grasps, for each of a plurality of wireless terminals, a wireless terminal capable of short-range wireless connection with the wireless terminal in the first embodiment.

FIG. 16 is a diagram illustrating an example of a method in which a wireless control device grasps, for each of a plurality of wireless terminals, a wireless terminal capable of short-range wireless connection with the wireless terminal in the first embodiment.

FIG. 17 is a diagram illustrating a configuration example of a wireless communication system according to a second embodiment.

FIG. 18 is a diagram illustrating a configuration example of a wireless communication system according to a third embodiment.

FIG. 19 is a diagram showing another configuration example of the wireless communication system according to the third embodiment.

FIG. 20 is a diagram illustrating an example of a method of grouping wireless terminals by a wireless control device according to the third embodiment.

FIG. 21 is a diagram illustrating an example of a method of grouping wireless terminals by a wireless control device according to the third embodiment.

FIG. 22 is a diagram illustrating another example of a method of grouping wireless terminals by a wireless control device according to the third embodiment.

FIG. 23 is a diagram illustrating an example of a method in which a wireless network controller selects a bridge terminal in a fourth embodiment.

FIG. 24 is a diagram illustrating another example of a method in which a wireless network controller selects a bridge terminal in the fourth embodiment.

FIG. 25 is a diagram illustrating a configuration example of a wireless communication system according to another embodiment.

### DETAILED DESCRIPTION

For clarity of explanation, the following description and drawings are appropriately omitted and simplified. In addition, the elements described in the drawings as functional blocks for performing various processes can be configured as CPUs (Central Processing Unit), memories, and other circuits in terms of hardware, and are realized by programs loaded into the memories in terms of software. Therefore, it is understood by those skilled in the art that these functional blocks can be realized in various forms by hardware alone, software alone, or a combination thereof, and the present invention is not limited to any of them. In the drawings, the same elements are denoted by the same reference numerals, and a repetitive description thereof is omitted as necessary.

Also, the programs described above may be stored and provided to a computer using various types of non-transitory computer readable media. Non-transitory computer readable media includes various types of tangible record media. Examples of non-transitory computer-readable media include magnetic recording media (e.g., flexible disks, magnetic tapes, hard disk drives), magneto-optical recording media (e.g., magneto-optical disks, CD-ROM (Compact Disc Read OnlyMemory), CD-R(CD Recordable), CD-R/W (CD ReWritable, solid-state memories (e.g., masked ROM, PROM (Programmable ROM), EPROM (Erasable PROM, flash ROM, RAM (Random Access Memory)). The program may also be supplied to the computer by various types of transitory computer-readable media. Examples of transitory computer-readable media include electrical signals, optical signals, and electromagnetic waves. The transitory computer-readable medium may provide the program to the computer via wired or wireless communication paths, such as electrical wires and optical fibers.

### Embodiment 1

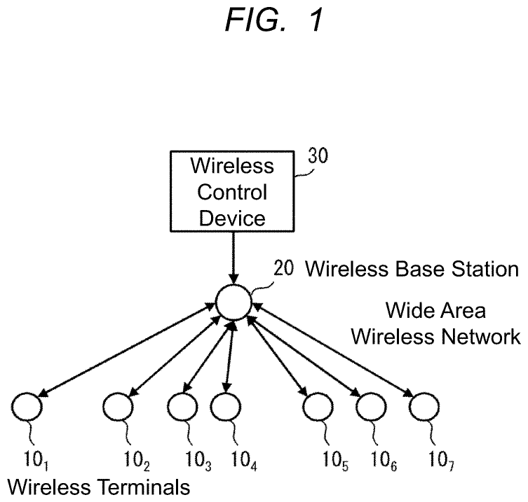

FIG. 1 shows a configuration example of a wireless communication system according to Embodiment 1. As shown in FIG. 1, the wireless communication system according to the first embodiment includes a plurality of wireless terminals 10 1 to 10L (L is a natural number of 2 or more; hereinafter, referred to as a wireless terminal 10 when the wireless terminals 10 1 to 10L are not specified), a wireless base station 20, and a wireless control device 30. FIG. 1 shows an example of L=7. In FIG. 1, only one wireless base station 20 is disposed under the wireless control device 30, but the present invention is not limited thereto, and two or more wireless base stations 20 may be disposed under the wireless control device 30.

The wireless terminal 10 is driven by a battery 11. The wireless terminal 10 is a terminal that transmits communication data such as sensor data to the wireless base station 20, and is, for example, an IoT (Internet of Things) device or the like.

The wireless base station 20 is connected to a plurality of wireless terminals 10, and manages the plurality of wireless terminals 10. The wireless base station 20 and a plurality of wireless terminals 10 constitute a wide area wireless network. The wireless control device 30 is connected to the wireless base station 20, and controls communication rates, communication frequencies, communication intervals, notification contents, and the like of communications between a plurality of wireless terminals 10 and the wireless base station 20.

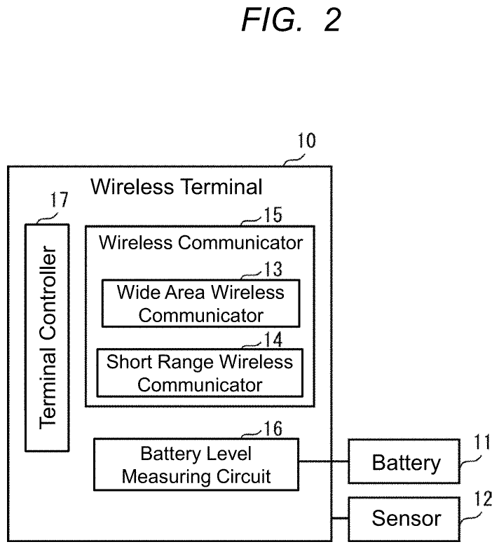

FIG. 2 shows a configuration example of the wireless terminal 10 according to the first embodiment. As shown in FIG. 2, the wireless terminal 10 according to the first embodiment includes a wireless communicator (wireless communication circuit) 15, a battery level measuring circuit 16, and a terminal controller (terminal control circuit) 17. The wireless communication circuit 15 includes a wide area wireless communication circuit 13 (first wireless communication circuit) and a short distance wireless communication circuit 14 (second wireless communication circuit). The wireless terminal 10 according to the first embodiment is driven by a battery 11 and connected to a sensor 12.

The wide area wireless communication circuit 13 performs wide area wireless communication (communication using the first communication function) with the wireless base station 20 on the wide area wireless network. Wide area wireless communication is wireless communication performed on wide area wireless networks such as LoRa WAN (Wide Area Network, for example, and is characterized in that the communication distances are long, but the communication rates are lower and the communication times are long, so that the consumption power is large.

The short-range wireless communication circuit 14 performs short-range wireless communication (communication using the second communication function) with another wireless terminal 10 located at a shorter distance than the wireless base station 20. The short-range wireless communication is characterized in that the communication distance is short as compared with the wide-area wireless communication, but the communication rate is high. The short-range wireless communication is characterized in that the power consumption is smaller than that of the wide-area wireless communication if the amount of data is the same. Further, the short-distance wireless communication has a feature that the transmission power can be reduced even at the same communication rate because the communication distance is short distance.

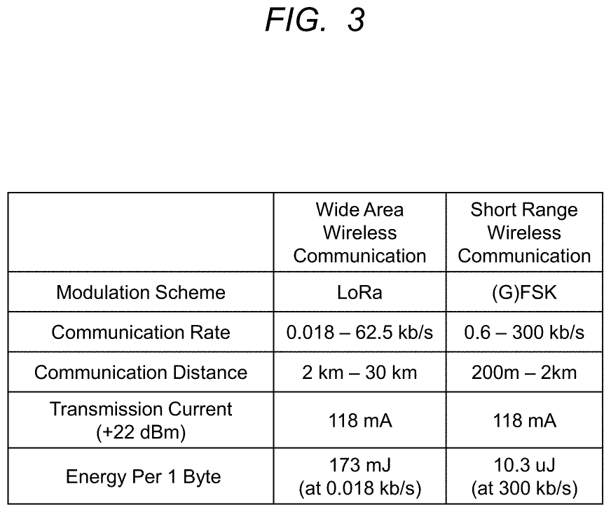

FIG. 3 shows examples of specifications of wide area wireless communication using a modulation scheme (LoRa (Long Range) and short-range wireless communication using a modulation scheme (G)FSK (Gaussian Frequency-Shift Keying) as an example of a LPWA communication scheme.

The battery 11 is used to drive the wireless terminal 10. The battery 11 is, for example, a dry battery, a button battery, or the like. The battery level measuring circuit 16 measures the remaining amount of the battery 11.

The sensor 12 acquires communication data (e.g., sensor data) to be transmitted to the wireless network controller 30 via the wireless base station 20. The communication data acquired by the sensor 12 is, for example, data of a gas meter, data of a power meter, data of weather, data of precipitation amount and snowfall amount, and the like. The sensor 12 may be mounted on the wireless terminal 10.

The terminal control unit 17 controls all functions in order to execute the respective functions in the wireless terminal 10. The operation of the wireless terminal 10 described below is performed by the terminal control unit 17 controlling the components in the wireless terminal 10, unless otherwise described.

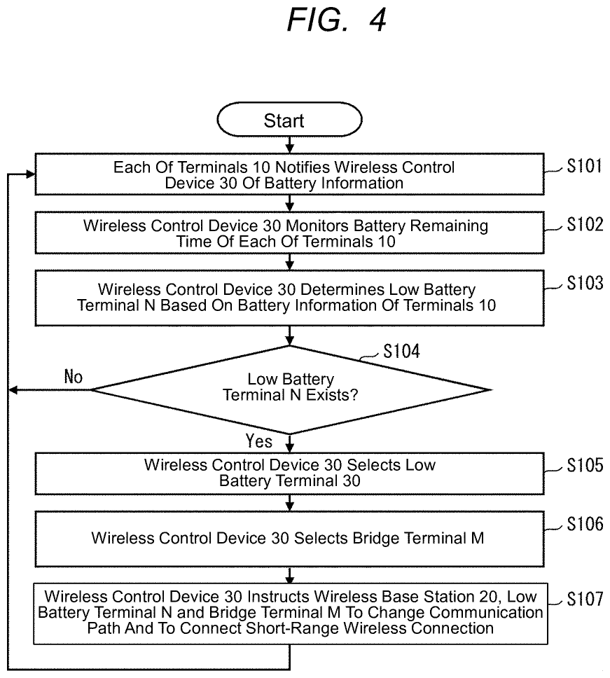

Hereinafter, a flow of a procedure for changing the wireless connection of the wireless terminal 10 having a short battery remaining time in the first embodiment will be described. First, a flow performed in a state in which the bridge terminal M is not selected will be described with reference to FIG. 4.

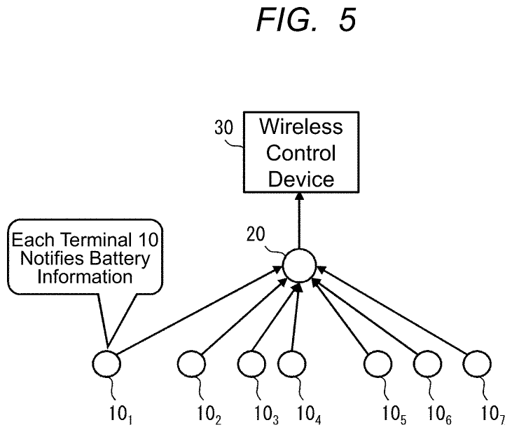

As shown in FIG. 4, each of the plurality of wireless terminals 10 periodically uses the wide area wireless communication circuit 13 to notify the wireless control device 30 of battery information indicating the remaining capacity of the battery 11 via the wireless base station 20 (step S101 of FIG. 4; FIG. 5).

Note that although the notification of the battery information is periodically performed here, the notification of the battery information may not be periodic or may be irregular. For example, in response to a request from the wireless control device 30 to each wireless terminal 10, each wireless terminal 10 may notify the wireless control device 30 of the battery information. Alternatively, each wireless terminal 10 may voluntarily notify the wireless control device 30 of the battery information in accordance with the remaining battery level of the battery 11, for example, when the remaining battery level becomes low.

Next, the wireless control device 30 calculates the battery remaining time of each of the plurality of wireless terminals 10 based on the battery information of each of the plurality of wireless terminals 10, and monitors the battery remaining time of each of the plurality of wireless terminals 10 in step S102 of FIG. 4. In the calculation of the battery remaining time, for example, the battery remaining time may be simply calculated to be shorter as the remaining battery level of the battery 11 decreases. Alternatively, as will be described later, a predicted value of the battery remaining time in the future may be calculated.

Next, the wireless control device 30 determines whether or not there is a low battery remaining-capacity terminal N (first wireless terminal) which is the wireless terminal 10 with a short battery-driven remaining-time (step S103 in FIG. 4). In the determination of the presence or absence of the low battery terminal N, it may be determined that the low battery terminal N is present if, for example, the wireless terminal 10 whose battery driving remaining time is equal to or less than the first threshold time is present. Alternatively, if there is a wireless terminal 10 whose battery remaining time is shorter than the average battery remaining time of the plurality of wireless terminals 10 by the second threshold time or more, it may be determined that there is a low battery terminal N.

When there is no wireless terminal 10 serving as the low battery remaining capacity terminal N (No in Step S104 of FIG. 4), the wireless control device 30 returns to Step S101 of FIG. 4, and waits until each of the plurality of wireless terminals 10 comes to a subsequent periodic timing for notifying the battery information.

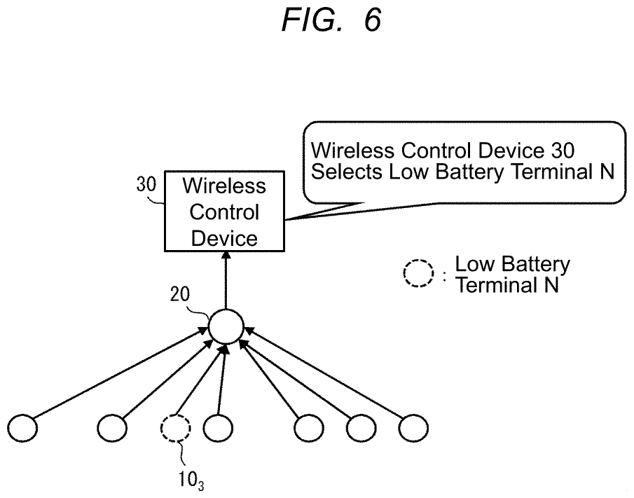

On the other hand, when the wireless terminal 10 serving as the low battery remaining capacity terminal N exists (Yes in step S104 of FIG. 4), the wireless control device 30 selects the wireless terminal 10 as the low battery remaining capacity terminal N (step S105 of FIG. 4; FIG. 6). In FIG. 6, the wireless terminal 103 is selected as the low battery remaining capacity terminal N.

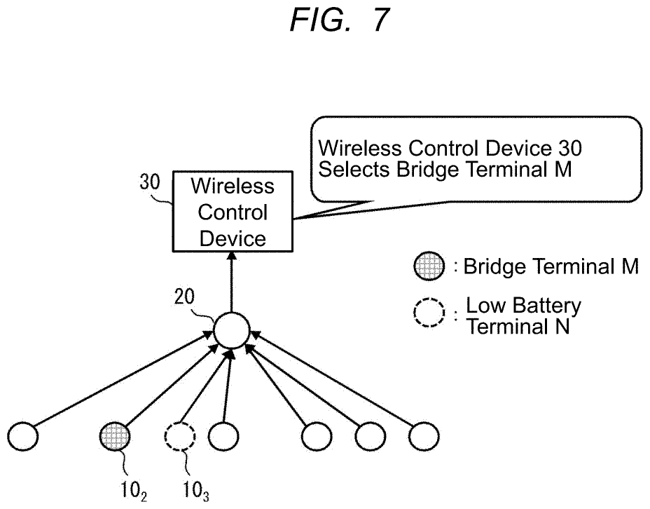

Next, the wireless controller 30 selects a bridge terminal M (second wireless terminal) for bridging the communication of the wireless terminal 10 selected as the low battery remaining capacity terminal N in the step S105 of FIG. 4 (step S106 of FIG. 7). Here, the wireless controller 30 selects, as the bridging terminal M, a wireless terminal 10 having a long remaining battery-driven time from among the wireless terminals 10 that can be connected by short-distance wireless to the wireless terminal 10 selected as the low battery remaining-capacity terminal N in the step S105 of FIG. 4. In FIG. 7, the wireless terminal 102 is selected as the bridge terminal M.

In the selection of the bridge terminal M, for example, the wireless terminal 10 having the battery remaining time equal to or longer than the third threshold time may be selected as the bridge terminal M from the wireless terminals 10 which are selected as the low battery remaining capacity terminal N in the step S105 of FIG. 4 and the wireless terminals 10 which can be connected by short-distance wireless. Alternatively, a wireless terminal 10 having a battery remaining time longer than the average time of the battery remaining times of the plurality of wireless terminals 10 by the fourth threshold time or longer may be selected as the bridging terminal M from among the wireless terminals 10 which can be connected to the wireless terminal 10 as the low battery terminal N in the step S105 of FIG. 4 by short-distance wireless communication. As will be described later, it is assumed that the wireless control device 30 grasps, for each of a plurality of wireless terminals 10, the wireless terminal 10 capable of short-range wireless connection with the wireless terminal 10.

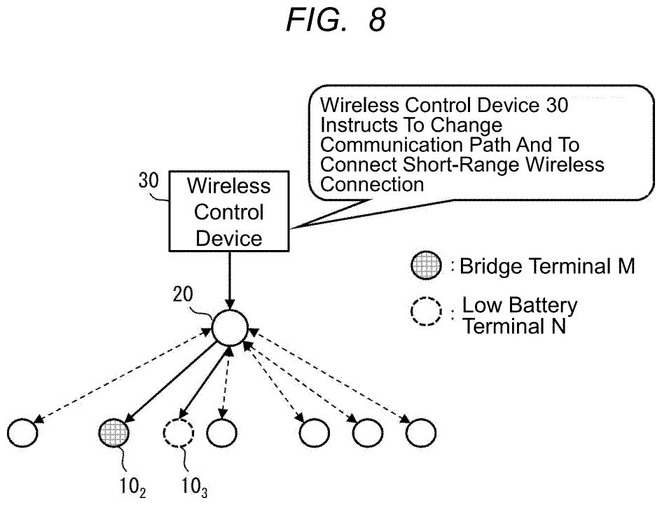

Subsequently, the wireless control device 30 changes the communication path between the low battery terminal N and the wireless base station 20 to a communication path that communicates between the low battery terminal N and the wireless base station 20 via the bridge terminal M, and instructs the wireless base station 20, the low battery terminal N, and the bridge terminal M to connect by short-distance wireless (FIG. 8: Step S107 of FIG. 4).

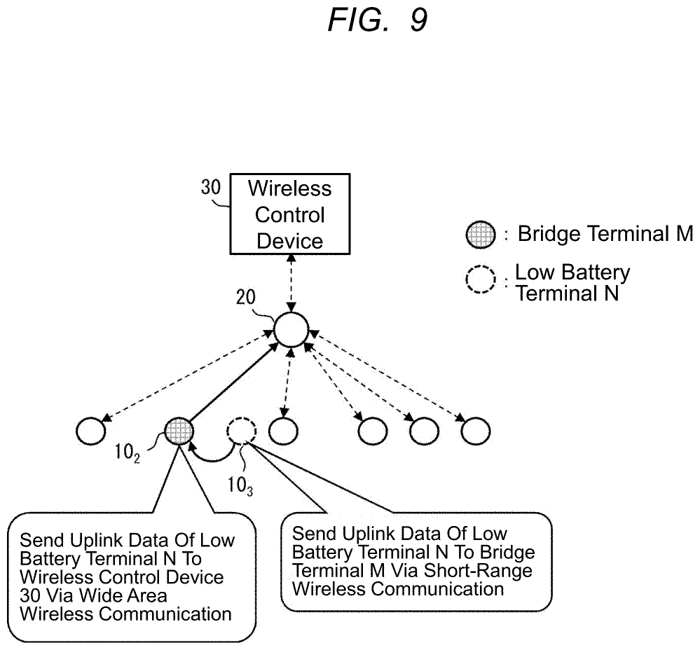

At this time, the wireless control device 30 may notify the communication timing and the communication rate together with the above-mentioned instructions. In this case, the communication rate may be a maximum rate at which communication can be performed between the low battery terminal N and the bridge terminal M. In addition, the low battery terminal N and the bridge terminal M may perform communication at a rate smaller than the maximum rate depending on the communication state. Thereafter, as shown in FIG. 9, the low battery terminal N transmits uplink data (including at least one of communication data and battery information) transmitted from the low battery terminal N to the wireless base station 20 to the bridge terminal M using the short-range wireless communication circuit 14, and the bridge terminal M transmits the uplink data to the wireless base station 20 using the wide-area wireless communication circuit 13.

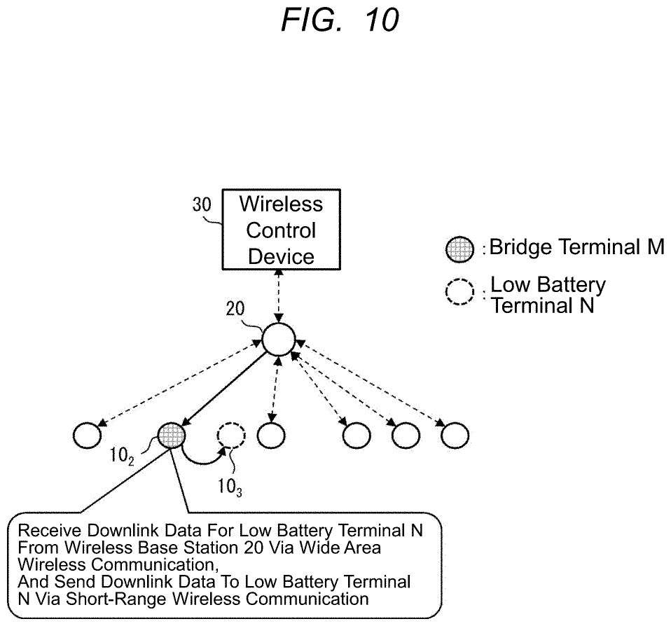

The downlink data (including communication data) transmitted from the wireless base station 20 to the low battery remaining capacity terminal N is also transmitted through the same communication path. That is, as shown in FIG. 10, the bridge terminal M receives the downlink data from the wireless base station 20 using the wide area wireless communication circuit 13, and transmits the downlink data to the low battery terminal N using the short distance wireless communication circuit 14.

The bridge terminal M may simultaneously communicate the data of the bridge terminal M (including the uplink data and the downlink data) and the data of the low battery terminal N (including the uplink data and the downlink data) with the wireless base station 20, or may separately communicate the data of the bridge terminal M and the data of the low battery terminal N. Comparing the former simultaneous communication with the latter separate communication, the former simultaneous communication is advantageous in terms of reducing communication resources.

Thereafter, the wireless control device 30 returns to the step S101 of FIG. 4 and waits until the next periodic timing at which each of the plurality of wireless terminals 10 notifies of the battery information comes.

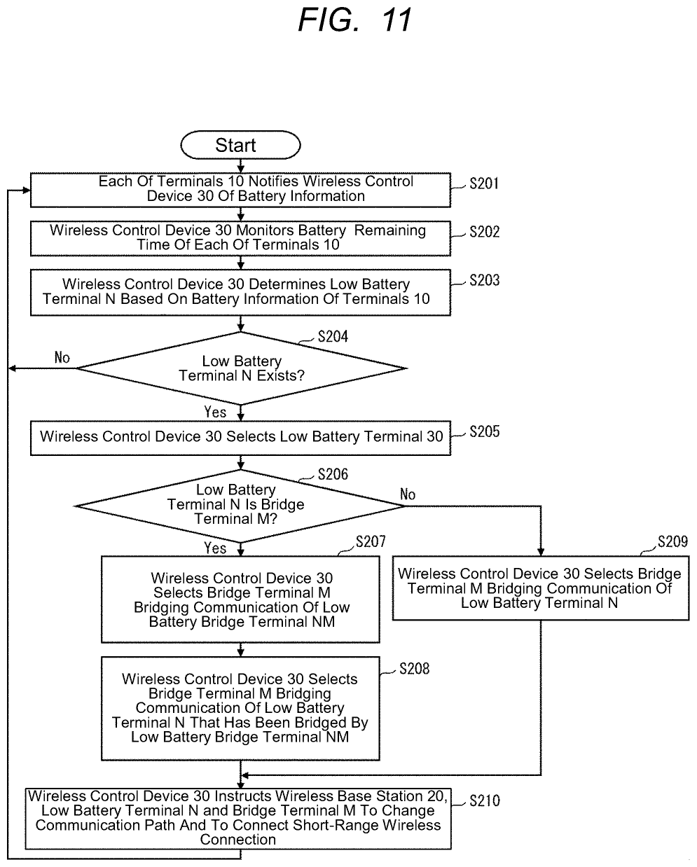

Next, as a flow of a procedure for changing the wireless connection of the wireless terminal 10 having a short battery remaining time in the first embodiment, a flow performed in a state where the bridge terminal M has already been selected will be described with reference to FIG. 11.

As shown in FIG. 11, each of the plurality of wireless terminals 10 periodically notifies the wireless control device 30 of the battery information via the wireless base station 20. At this time, the bridge terminal M has already been selected. Therefore, the low battery terminal N transmits the battery information to the bridge terminal M using the short-range wireless communication circuit 14. The bridge terminal M uses the wide area wireless communication circuit 13 to notify the wireless control device 30 of the battery information of the low battery terminal N and the bridge terminal M via the wireless base station 20. At this time, when there is communication data to be transmitted to the wireless control device 30 in the low battery terminal N and the bridge terminal M, the communication data may be transmitted to the wireless control device 30 simultaneously with the battery information, or may be transmitted to the wireless control device 30 separately from the transmission of the battery information. Similarly to step S101, the wireless terminal 10 other than the low-battery-remaining-capacity terminal N and the bridging terminal M uses the wide-area wireless communication circuit 13 to notify the wireless control device 30 of the battery information via the wireless base station 20 (step S201 in FIG. 11; FIG. 9).

Next, the wireless control device 30 calculates the battery remaining time of each of the plurality of wireless terminals 10 based on the battery information of each of the plurality of wireless terminals 10, and monitors the battery remaining time of each of the plurality of wireless terminals 10 in step S202 of FIG. 11. It should be noted that the method of calculating the battery remaining time in step S202 of FIG. 11 may be the same as the method of step S102 of FIG. 4.

Subsequently, the wireless control device 30 determines the presence or absence of the low battery terminal N (step S203 in FIG. 11), and when the wireless terminal 10 serving as the low battery terminal N does not exist (step S204 in FIG. 11, NO), the wireless control device 30 returns to the step S201 in FIG. 11, and waits until the next periodic timing at which each of the plurality of wireless terminals 10 notifies of the battery information comes. The determination of the presence or absence of the low battery remaining capacity terminal N in step S203 of FIG. 11 may be performed in the same manner as in step S103 of FIG. 4.

On the other hand, when the wireless terminal 10 serving as the low battery remaining capacity terminal N exists (Yes in step S204 of FIG. 11), the wireless control device 30 selects the wireless terminal 10 as the low battery remaining capacity terminal N (step S205 of FIG. 11).

Next, in step S206 of FIG. 11, the wireless controller 30 determines whether the wireless terminal 10 selected as the low-battery remaining-capacity terminal N in step S205 of FIG. 11 was the bridging terminal M.

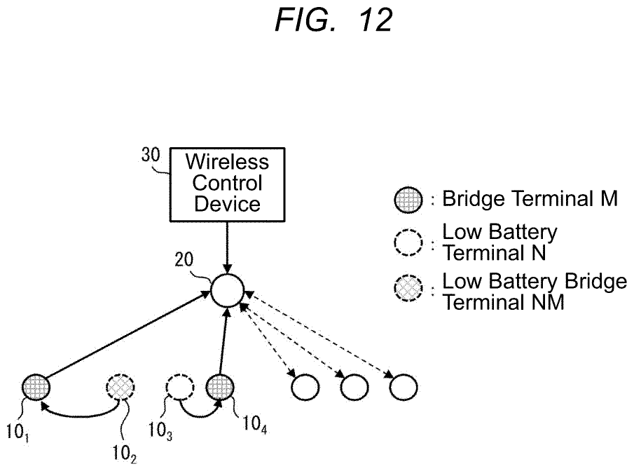

When the wireless terminal 10 selected as the low battery terminal N in step S205 of FIG. 11 has been the bridge terminal M (hereinafter, this wireless terminal 10 is referred to as the low battery remaining amount bridge terminal NM) (Yes in step S206 of FIG. 11), the wireless control device 30 then selects the bridge terminal M that bridges the communication of the low battery remaining amount bridge terminal NM selected as the low battery terminal N in step S205 of FIG. 11 (step S207 of FIG. 11). In addition, since the low battery remaining amount bridge terminal NM selected as the low battery terminal N in the step S205 of FIG. 11 has been the bridge terminal M, there is another low battery terminal N to which the low battery remaining amount bridge terminal NM has already bridged as the bridge terminal M. Therefore, the wireless controller 30 also selects a bridge terminal M that bridges communication of another low battery terminal N to which the low battery remaining amount bridge terminal NM selected as the low battery terminal N in step S205 of FIG. 11 has been bridged (step S208 of FIG. 11). The method of selecting the bridging terminal M in step S207,S208 of FIG. 11 may be the same as the method of step S106 of FIG. 4. The bridging terminal M selected in the step S207,S208 of FIG. 11 may be the same wireless terminal 10 or may be a different wireless terminal 10. For example, FIG. 12 shows an example in which the wireless terminal 102, which was the bridge terminal M in FIGS. 6 to 10, becomes the low battery remaining amount bridge terminal NM. In FIG. 12, in the step S207 of FIG. 11, for example, the wireless terminal 101 is selected as the bridge terminal M that bridges the communication of the low-battery remaining-capacity bridge terminal NM, i.e., the wireless terminal 102. In FIG. 12, in the step S208 of FIG. 11, for example, the wireless terminal 104 is selected as the bridge terminal M that bridges the communication of another low battery terminal N (wireless terminal 103) to which the low battery remaining amount bridge terminal NM (wireless terminal 102) has already bridged. However, in the step S207,S208 of FIG. 11, the same wireless terminal 101 or the same wireless terminal 104 may be selected as the bridging terminal M.

On the other hand, when the wireless terminal 10 selected as the low battery terminal N in step S205 of FIG. 11 is not the bridge terminal M until then (NO in step S206 of FIG. 11), the wireless control device 30 then selects the bridge terminal M that bridges the communication of the wireless terminal 10 selected as the low battery terminal N in step S205 of FIG. 11 (step S209 of FIG. 11).

Subsequently, the wireless control device 30 instructs the wireless base station 20, the low battery terminal N (low battery remaining amount bridge terminal NM), and the bridge terminal M to change the communication path between the low battery terminal N (low battery remaining amount bridge terminal NM) and the wireless base station 20 to a communication path communicating between the low battery terminal N (low battery remaining amount bridge terminal NM) and the wireless base station 20 via the bridge terminal M, and to connect the low battery terminal N (low battery remaining amount bridge terminal NM) and the bridge terminal M by short-distance wireless (step S210 in FIG. 11).

Thereafter, the wireless control device 30 returns to the step S201 of FIG. 11, and waits until the next periodic timing at which each of the plurality of wireless terminals 10 notifies of the battery information comes.

Here, the selection of the low battery terminal N and the bridge terminal M is performed at a periodic timing for notifying the battery information, but the present invention is not limited to this. For example, an event such as a request from a client or the like may be used as a trigger to select the low battery terminal N and the bridge terminal M or the like irregularly.

Hereinafter, in the first embodiment, a method in which the wireless control device 30 grasps, for each of a plurality of wireless terminals 10, the wireless terminal 10 capable of short-range wireless connection with the wireless terminal 10 will be described. Examples of the method include the following five methods A1 to A5.

(1) Method A1: In the case where each of the plurality of wireless terminals 10 is a terminal to be fixedly installed, when installing the plurality of wireless terminals 10, the wireless control device 30 grasps the wireless terminal 10 capable of short-range wireless connection with the wireless terminal 10 for each of the plurality of wireless terminals 10 on the basis of the installation position of each of the plurality of wireless terminals 10.

(2) Method A2: Each of the plurality of wireless terminals 10 is provided with a position information grasping system such as a GPS (Global Positioning System) system, and notifies the wireless control device 30 of the location information. The wireless control device 30 grasps, for each of the plurality of wireless terminals 10, the wireless terminal 10 capable of short-range wireless connection with the wireless terminal 10 on the basis of the position of each of the plurality of wireless terminals 10.

(3) Method A3: Each of the plurality of wireless terminals confirms the communication state of the short-distance communication with the other wireless terminal 10, and notifies the wireless control device 30 of the confirmation result of the communication state. The wireless control device 30 grasps, for each of the plurality of wireless terminals 10, the wireless terminal 10 capable of short-range wireless connection with the wireless terminal 10 on the basis of the confirmation result of the communication state of the short-range communication of each of the plurality of wireless terminals 10.

(4) Method A4: In the case where each of the plurality of wireless terminals 10 can capture wireless waves of three or more wireless base stations 20, the wireless control device 30 is notified of the received power when the wireless waves are received from the three or more wireless base stations 20. The wireless control device 30 calculates the position of each of the plurality of wireless terminals 10 by using the three-point surveying method. The subsequent steps are the same as those of the method A2.

(5) Method A5: Combining the methods A1 to A4 described above. That is, it is not necessary for the wireless control device 30 to grasp the wireless terminals 10 capable of short-range wireless connection in the same manner for all the wireless terminals 10. For example, the wireless control device 30 may grasp one wireless terminal 10 by a method A1, and may grasp another wireless terminal 10 by a method other than the method A1.

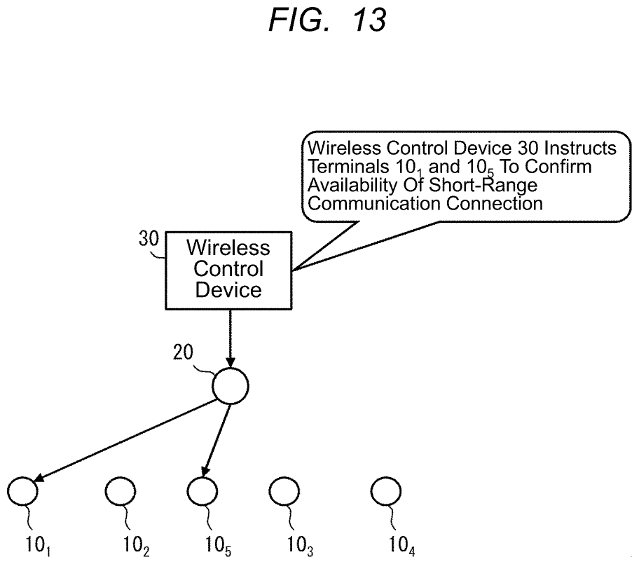

Hereinafter, the method A3 will be described with reference to FIGS. 13 to 16. FIGS. 13 to 16 show an example in which the wireless terminal 105 is additionally installed in a situation where the wireless terminals 101 to 104 are already installed.

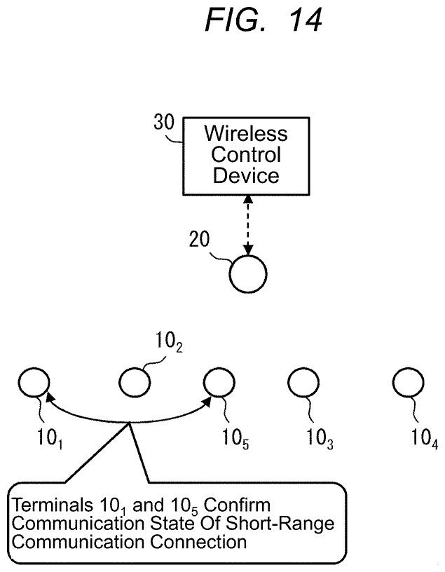

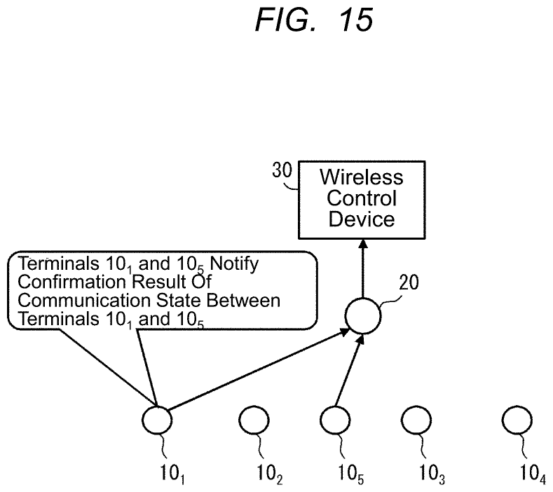

First, as shown in FIG. 13, the wireless control device 30 instructs the wireless terminals 101 and 105 via the wireless base station 20 to confirm whether or not short-range wireless connection is possible. Next, as shown in FIG. 14, the communication status of the short-range wireless communication is checked between the wireless terminals 101 and 105 using the short-range wireless communication circuit 14. Subsequently, as shown in FIG. 15, the wireless terminals 101 and 105 report the confirmation result of the communication state of the short-range wireless communication between the wireless terminals 101 and 105 to the wireless control device 30 via the wireless base station 20 by using the wide area wireless communication circuit 13.

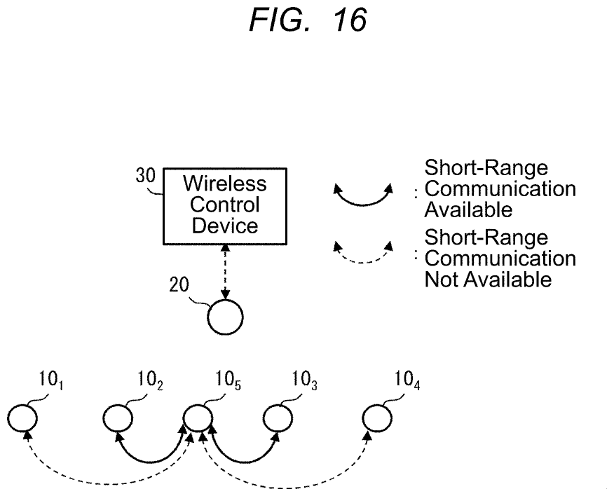

Hereinafter, the processing described with reference to FIGS. 13 to 15 is also executed for the wireless terminals 102 to 104. In this manner, as shown in FIG. 16, the wireless network controller 30 examines and grasps the wireless terminal 10 to which the additionally installed wireless terminal 105 is capable of short-range wireless connection. In the example of FIG. 16, the wireless control device 30 grasps the wireless terminals 102 and 103 as the wireless terminal 10 to which the wireless terminal 105 is capable of short-range wireless connection.

In the examples of FIGS. 13 to 16, the confirmation of whether or not the short-range wireless connection with the wireless terminal 105 is possible is sequentially performed for each of the wireless terminals 101 to 104 that have already been installed, but the present invention is not limited thereto. For example, the wireless terminal 105 may simultaneously transmit a predetermined signal using the short-range wireless communication circuit 14, the wireless terminals 101 to 104 may report to the wireless control device 30 the reception result as to whether or not the signal from the wireless terminal 105 has been received, and the wireless control device 30 may grasp the wireless terminal 10 capable of short-range wireless connection with the wireless terminal 105 based on the reception result of the wireless terminals 101 to 104.

In the examples of FIGS. 13 to 16, the wireless terminal 10 capable of short-range wireless connection with the wireless terminal 105 is grasped when the wireless terminal 105 is additionally installed, but the present invention is not limited thereto. For example, when a terminal group consisting of a plurality of wireless terminals 10 is installed first, or at regular timing, the grasping of wireless terminals 10 capable of short-range wireless connection may be performed for each of the plurality of wireless terminals 10.

As described above, according to the first embodiment, the wireless control device 30 selects the wireless terminal 10 as the low battery terminal N when there is the wireless terminal 10 having the short battery remaining time based on the battery information of each of the plurality of wireless terminals 10, and selects the wireless terminal 10 having the long battery remaining time as the bridge terminal M when the low battery terminal N is selected. Then, the wireless controller 30 instructs the wireless base station 20, the low battery terminal N, and the bridge terminal M to change the communication path between the low battery terminal N and the wireless base station 20 to a communication path communicating between the low battery terminal N and the wireless base station 20 via the bridge terminal M, and to connect the low battery terminal N and the bridge terminal M by short-distance wireless. After receiving this instruction, the low battery remaining capacity terminal N transmits uplink data to be transmitted to the wireless base station 20 to the bridge terminal M using short-range wireless communication, and the bridge terminal M transmits the uplink data to the wireless base station 20 using wide-area wireless communication. In addition, the bridge terminal M receives downlink data to be transmitted to the low battery terminal N from the wireless base station 20 using wide area wireless communication, and transmits the downlink data to the low battery terminal N using short distance wireless communication.

Therefore, the small battery remaining amount terminal N having a short battery remaining time consumes less battery by performing short-range wireless communication with low power consumption, and the operation time can be increased. In addition, by performing short-range wireless communication with low power consumption in the wide area wireless network, it is possible to increase the operating time of the wireless terminal 10 as a whole system.

In addition, the bridge terminal M having a long battery remaining time consumes more batteries by performing wide area wireless communication having a large power consumption instead of the low battery terminal N, and as a result, the battery remaining time of the bridge terminal M approaches the battery remaining time of the low battery terminal N. Therefore, since the battery remaining time of the plurality of wireless terminals 10 can be made uniform, the battery replacement timing of the plurality of wireless terminals 10 can be made uniform, and the battery replacement cost of the wireless terminal 10 can be reduced.

### Embodiment 2

Embodiment 2 is an example applied to various wide area wireless networks in which the number of wireless terminals 10 is large and the distance between the low battery terminal N and the bridge terminal M is long.

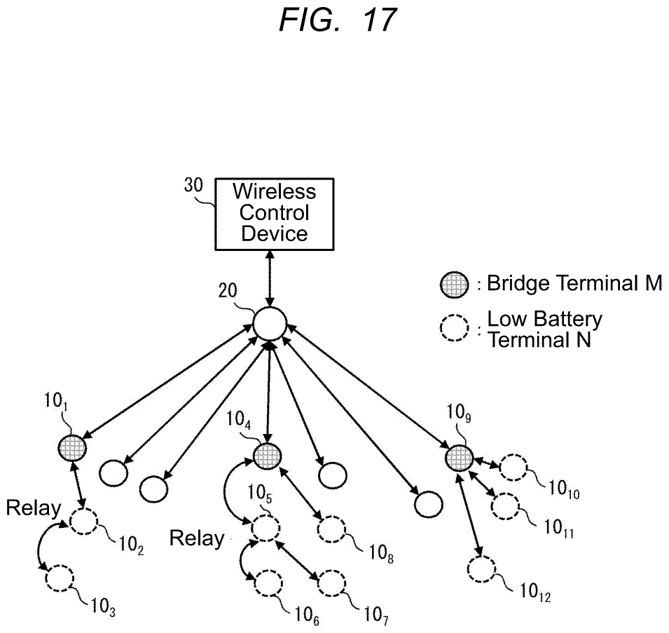

FIG. 17 shows a configuration example of a wireless communication system according to the second embodiment. In the example shown in FIG. 17, the wireless control device 30 selects two wireless terminals 102 and 103 as the low battery terminal N, and selects the wireless terminal 101 as the bridge terminal M of the two wireless terminals 102 and 103. However, since the distance between the wireless terminals 101 and 103 is long, the wireless control device 30 selects the wireless terminal 102 as a wireless terminal (third wireless terminal) that relays communication between the wireless terminals 101 and 103.

In this case, the wireless control device 30 instructs the wireless connection, for example, as follows. That is, the wireless control device 30 instructs the wireless base station and the wireless terminals 101 and 102 to change the communication path between the wireless terminal 102 and the wireless base station 20 to a communication path that communicates between the wireless terminal 102 and the wireless base station 20 via the wireless terminal 101, and to connect the wireless terminals 101 and 102 by short-distance wireless. In addition, the wireless control device 30 instructs the wireless base station 20 and the wireless terminals 101 to 103 to change the communication path between the wireless terminal 103 and the wireless base station 20 to a communication path communicating between the wireless terminal 103 and the wireless base station 20 via the wireless terminals 101 and 102, and to connect the wireless terminals 101 and 102 and the wireless terminals 102 and 103 by short-distance wireless.

In addition, the wireless control device 30 selects the four wireless terminals 105 to 108 as the low battery terminal N, and selects the wireless terminal 104 as the bridge terminal M of the four wireless terminals 105 to 108. However, since the distances between the wireless terminals 104 and 106 and between the wireless terminals 104 and 107 are long, the wireless control device 30 selects the wireless terminal 105 as a low battery terminal for relaying communications from a plurality of low battery terminals as a wireless terminal for relaying communications between the wireless terminals 104 and 106 and communications between the wireless terminals 104 and 107. In this case, the wireless connection instruction by the wireless control device 30 is the same as the above-described instruction. Further, the wireless terminal 104 is selected as a bridge terminal that relays communications from a plurality of low battery remaining terminals.

In addition, the wireless control device 30 selects three wireless terminals 1010 to 1012 as the low battery terminal N, and selects the wireless terminal 109 as the bridge terminal M of the three wireless terminals 1010 to 1012. In this case, the wireless connection instruction by the wireless control device 30 is the same as the above-described instruction.

In the example of FIG. 17, the wireless terminal 10 that relays communication is a low battery terminal N, but the present invention is not limited thereto. The wireless terminal 10 that relays communication may be a wireless terminal 10 other than the low battery remaining capacity terminal N.

As described above, according to the second embodiment, one bridge terminal M is selected for a plurality of low battery terminals N, another wireless terminal 10 relays communication between the low battery terminal N and the bridge terminal M, or a plurality of bridge terminals are selected.

Therefore, even in various wide area wireless networks in which the number of wireless terminals 10 is large and the distance between the low battery terminal N and the bridge terminal M is long, it is possible to increase the operating time of the wireless terminal 10, to equalize the battery remaining time of the plurality of wireless terminals 10, and to reduce the battery replacement cost of the wireless terminal 10.

### Embodiment 3

A third embodiment is an example in which a plurality of wireless terminals 10 are divided into groups and control is performed so as to equalize the battery remaining time of the wireless terminals 10 in the same group.

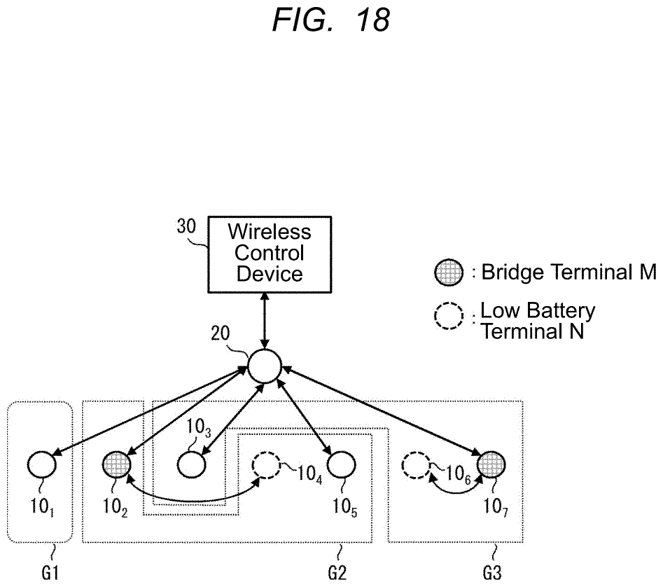

FIG. 18 shows a configuration example of a wireless communication system according to the third embodiment. In the example shown in FIG. 18, the wireless terminal 101 belongs to the group G1, the wireless terminals 102, 104, and 105 belong to the group G2, and the wireless terminals 103, 106, and 107 belong to the group G3.

Therefore, when the wireless terminal 104 belonging to the group G2 is selected as the low battery remaining capacity terminal N, the wireless control device 30 selects the wireless terminal 102 belonging to the same group G2 as the bridge terminal M of the wireless terminal 104. When the wireless terminal 106 belonging to the group G3 is selected as the low battery remaining capacity terminal N, the wireless control device 30 selects the wireless terminal 107 belonging to the same group G3 as the bridge terminal M of the wireless terminal 106.

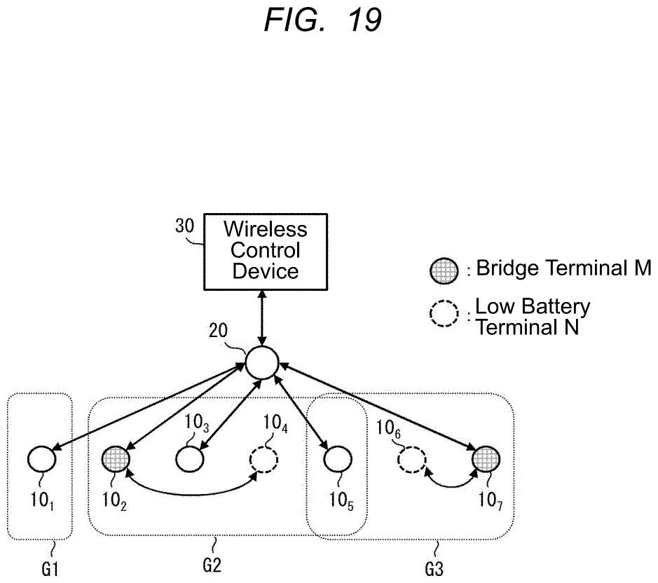

In the grouping of the wireless terminals 10, one wireless terminal 10 may belong to a plurality of groups. For example, in the example of FIG. 19, the wireless terminal 106 belongs to both the groups G2 and G3.

Hereinafter, a method of grouping the wireless terminals 10 by the wireless control device 30 in the third embodiment will be described.

For example, the wireless control device 30 may divide the wireless terminals 10 into groups according to the type of the wireless terminal 10, such as an application, an installation company, and the like. In addition, there are cases where the maintenance method differs between the wireless terminals 10 (e.g., the battery replacement timing differs depending on the maintenance company). Therefore, the wireless control device 30 may group the wireless terminals 10 according to the maintenance method of the wireless terminals 10.

Further, when each of the plurality of wireless terminals 10 is a terminal that is fixedly installed and is provided with a position information grasping system such as GPS, the wireless control device 30 may group the wireless terminals 10 using the position information of each of the plurality of wireless terminals 10.

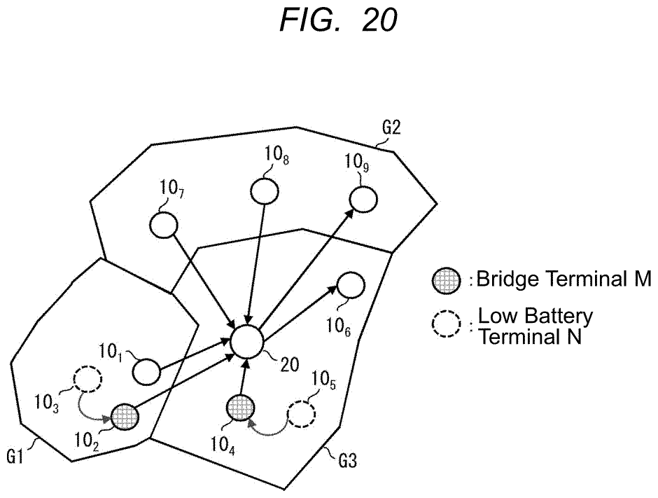

For example, as shown in FIG. 20, each of the plurality of wireless terminals 101 to 109 grasps the position using the position information grasping system, and reports the position information to the wireless control device 30. The wireless network controller 30 performs grouping based on the positions of each of the plurality of wireless terminals 101 to 109. For example, the wireless network controller 30 classifies the wireless terminals 10 installed in the same area, such as a municipality, into the same group. In the example of FIG. 20, the wireless network controller 30 classifies the wireless terminals 101 to 103 installed in the same area into a group G1. Similarly, the wireless terminals 104 to 106 are classified into a group G3, and the wireless terminals 107 to 109 are classified into a group G2.

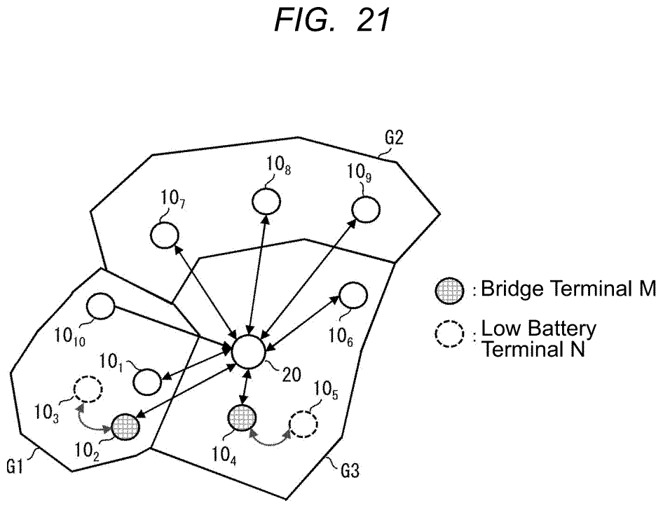

Further, from the installation state of FIG. 20, as shown in FIG. 21, when the wireless terminal 1010 is additionally installed, the wireless terminal 1010 grasps the position using the position information grasping system after installation, and reports the position information to the wireless control device 30. The wireless control device 30 recognizes in which region the wireless terminal 1010 is installed, and classifies the wireless terminal 1010 into one of groups. In the example of FIG. 21, the wireless terminal 1010 is installed in a region where the wireless terminals 101 to 103 are installed. Therefore, the wireless control device 30 classifies the wireless terminal 1010 into the same group G1 as the wireless terminals 101 to 103.

In addition, even if the position information grasping system is not used, when the wireless terminal 10 is installed and the location information of the installed wireless terminal 10 is obtained, the wireless control device 30 may perform grouping using the location information.

As described above, the wireless control device 30 can grasp the wireless terminal 10 capable of short-range wireless connection with the wireless terminal 10 for each of a plurality of wireless terminals 10 without using the position information grasping system. Therefore, the wireless control device 30 may perform grouping using the grasped result.

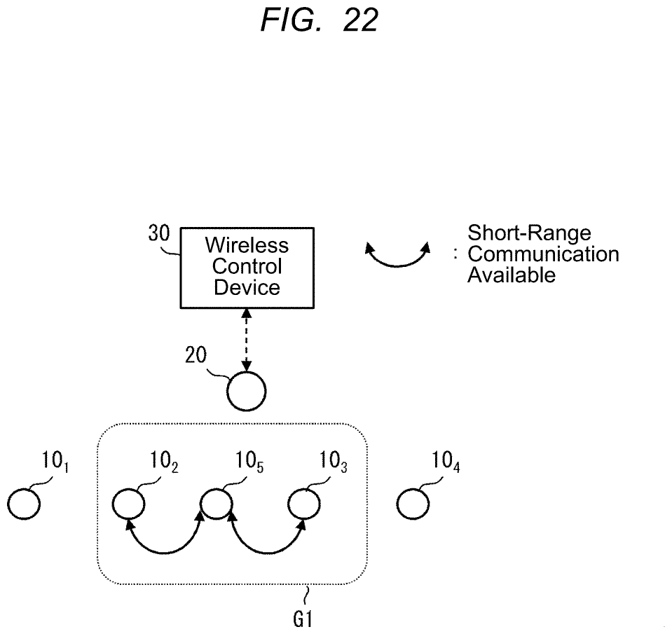

For example, as shown in FIG. 16, it is assumed that the wireless control device 30 has grasped the wireless terminals 102 and 103 as the wireless terminal 10 to which the additionally installed wireless terminal 105 is capable of short-range wireless connection. In this case, as shown in FIG. 22, the wireless control device 30 may classify the wireless terminals 102, 103, and 105 into the same group G1.

As described above, according to the third embodiment, the wireless control device 30 divides the plurality of wireless terminals 10 into groups, and selects the wireless terminals 10 belonging to the same group as the low battery terminal N as the bridge terminal M of the low battery terminal N. Therefore, it is possible to equalize the battery remaining time of the wireless terminals 10 in the same group and to align the battery replacement timing of the wireless terminals 10 in the same group.

### Embodiment 4

A fourth embodiment is an example in which the future battery driving remaining time of the wireless terminal 10 is predicted, and the low battery terminal N and the bridge terminal M are selected based on the prediction result.

Hereinafter, a method in which the wireless control device 30 selects the low battery terminal N and the bridge terminal M in the fourth embodiment will be described. As the method, for example, the following two methods B1 and B2 can be cited.

(1) Method B1: In the wireless terminal 10, when a component other than the wireless communication circuit 15 (e.g., the sensor 12) uses the same battery 11 as the wireless communication circuit 15, a method of decreasing the remaining battery capacity is changed depending on the usage frequency, usage amount, and the like of the battery 11 by a component other than the wireless communication circuit 15.

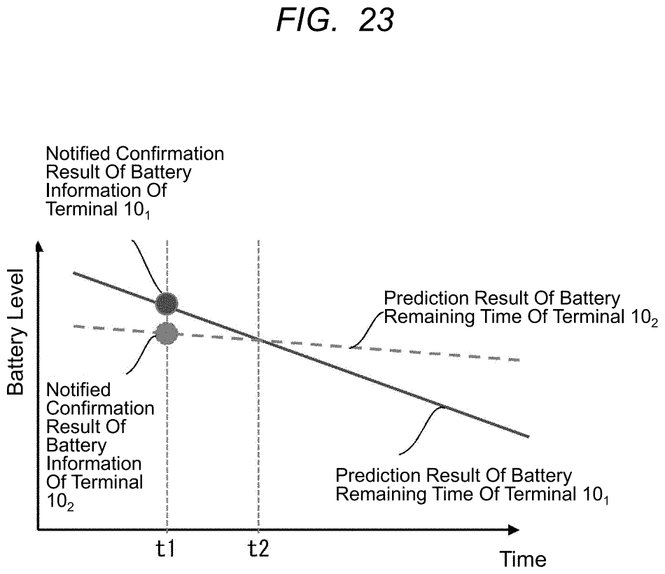

Therefore, the wireless control device 30 holds information used for prediction of the battery remaining time in each of a plurality of wireless terminals 10. This information is information obtained from the prediction result of the battery driving remaining time of the wireless terminal 10 predicted in the past, and reflects the usage frequency and usage amount of the battery 11 by components other than the wireless communication circuit 15. This information is, for example, as shown in FIG. 23 to be described later, information indicating the slope of a graph indicating the temporal transition of the remaining battery capacity of the wireless terminal 10. The wireless control device 30 predicts the battery remaining time of the wireless terminal 10 in the future by considering not only the battery information notified from the wireless terminal 10 but also information used for predicting the battery remaining time of the wireless terminal 10. Then, the wireless control device 30 selects the low battery terminal N and the bridge terminal M based on the prediction result of the battery driving remaining time.

FIG. 23 shows an example of the method B1. Note that FIG. 23 shows the result of the battery information notified from the wireless terminals 101 and 102 and the prediction result of the battery remaining time of each of the wireless terminals 101 and 102 in a situation where the constituent elements other than the wireless communication circuit 15 use the same battery 11 as the wireless communication circuit 15 in each of the wireless terminals 101 and 102. FIG. 23 shows an example of selecting the bridge terminal M from the wireless terminals 101 and 102.

In the example of FIG. 23, at the time t1, the wireless terminal 101 has a larger remaining battery capacity. However, when the wireless control device 30 predicts the battery remaining time of the wireless terminals 101 and 102 based on the remaining battery capacity at the time t1 of the battery 11 in the wireless terminals 101 and 102 and the information used for predicting the battery remaining time in the wireless terminals 101 and 102 (in the example of FIG. 23, the information representing the slope of the graph), the battery remaining time of the wireless terminal 102 becomes longer after the time t2. Therefore, the wireless control device 30 selects the wireless terminal 102 as the bridge terminal M based on the prediction result.

(2) Method B2: The wireless control device 30 accumulates battery information periodically notified from each of the plurality of wireless terminals 10. Then, for each of the plurality of wireless terminals 10, the wireless control device 30 predicts the battery remaining time of the wireless terminal 10 in the future based on the accumulation result of the battery information periodically collected from the wireless terminal 10, and selects the low battery terminal N and the bridge terminal M based on the prediction result of the battery remaining time.

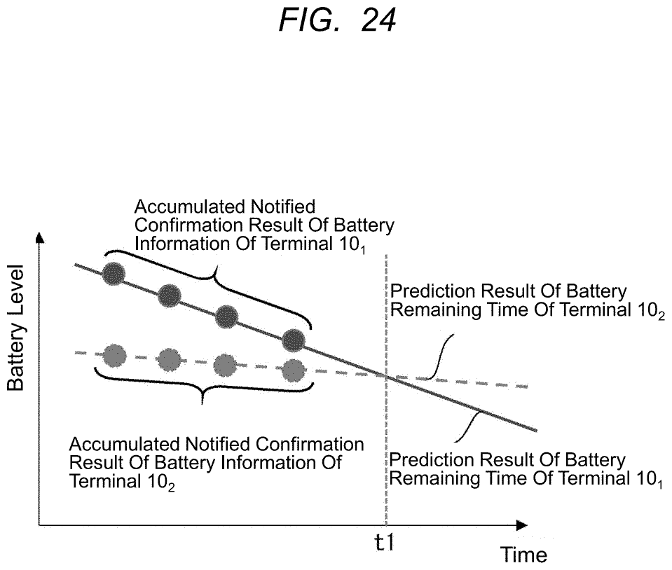

FIG. 24 shows an example of the method B2. Note that FIG. shows the accumulation result of the battery information periodically notified from each of the wireless terminals 101 and 102, and the prediction result of the battery remaining time of each of the wireless terminals 101 and 102. FIG. 24 shows an example in which the bridge terminal M is selected from the wireless terminals 101 and 102.

In the example of FIG. 24, before time t1, the wireless terminal 101 has a larger remaining battery capacity. However, when the wireless control device 30 predicts the battery remaining time of the wireless terminals 101 and 102 based on the time transition of the battery information of the wireless terminals 101 and 102, the battery remaining time of the wireless terminal 102 becomes longer after the time t2. Therefore, the wireless control device 30 selects the wireless terminal 102 as the bridge terminal M based on the prediction result.

As described above, according to the fourth embodiment, the wireless control device 30 predicts the future battery driving remaining time of each of the plurality of wireless terminals 10, and selects the low battery terminal N and the bridge terminal M based on the prediction result. Therefore, it is possible to select the wireless terminal 10 whose remaining battery time becomes shorter in the future than the other wireless terminal 10 as the low battery terminal N, or to select the wireless terminal 10 whose remaining battery-driven time becomes longer in the future than the other wireless terminal 10 as the bridge terminal M.

Although the invention made by the inventor has been specifically described based on the embodiment, the present invention is not limited to the embodiment already described, and it is needless to say that various modifications can be made without departing from the gist thereof.

For example, in the above embodiment, it is assumed that the batteries 11 of the plurality of wireless terminals 10 in the wireless communication system are batteries on the assumption that they are replaced, but the present invention is not limited thereto. The wireless communication system may include a wireless terminal 10 driven by a battery that can be charged at any time by a solar panel or the like, or a wireless terminal 10 driven by a fixed power source from a power outlet. Here, in the wireless terminal 10 driven by a battery that can be charged at any time or a fixed power source, the remaining battery level is not reduced, or the remaining battery level is reduced at a low rate. Therefore, the wireless control device 30 does not select the wireless terminal 10 driven by a battery or a fixed power source that can be charged at any time as the low battery terminal N, but may preferentially select the wireless terminal 10 as the bridge terminal M. When the wireless terminal 10 driven by a battery or a fixed power source that can be charged at any time is preferentially selected as the bridge terminal M, it is possible to increase the operating time of the wireless terminal 10 as a whole system.

In the above embodiment, the wireless control device 30 selects the low battery terminal N and the bridge terminal M based on the calculation result and the prediction result of the battery driving remaining time, but the present invention is not limited thereto. When the wireless controller 30 is connected to the cloud and obtains information from the cloud, such as weather information and traffic information, the wireless controller 30 may select the low battery terminal N and the bridge terminal M in consideration of these information. For example, when the use frequency of the sensor 12 of the wireless terminal 10 increases from weather information, traffic information, or the like (e.g., an increase in the continuation frequency of a rain gauge due to a deterioration in weather, an increase in the measurement frequency of traffic information due to an increase in the traffic volume, or the like) is predicted, it is considered that the power consumption increases, and therefore, the calculation result or the prediction result of the battery driving remaining time may be changed.

Further, in the above embodiment, the wireless terminal 10 selected as the low battery terminal N performs communication with the wireless base station 20 through the short-range wireless communication with the bridge terminal M without performing the wide-area wireless communication thereafter. However, in some wireless communication systems, the wireless terminal 10 cannot be disconnected from the wide area wireless network, and it is necessary to periodically communicate predetermined data with the wide area wireless network. In such a wireless communication system, even in a situation where the wireless terminal 10 selected as the low battery terminal N communicates with the wireless base station through the bridge terminal M, it is necessary to perform communication of predetermined data with the wireless base station 20 through a wide area wireless network, that is, wide area wireless communication.

In this case, the wireless terminal 10 selected as the low battery remaining capacity terminal N communicates predetermined data with the wireless base station 20 through wide area wireless communication at a periodic timing when it is necessary to communicate predetermined data with the wide area wireless network, and communicates with the wireless base station 20 through short-range wireless communication with the bridge terminal M at a timing other than the periodic timing. Further, at this periodic timing, in addition to predetermined data, data to be communicated with the wireless base station 20 through short-range wireless communication with the bridge terminal M may also be communicated with the wireless base station 20 through wide-area wireless communication.

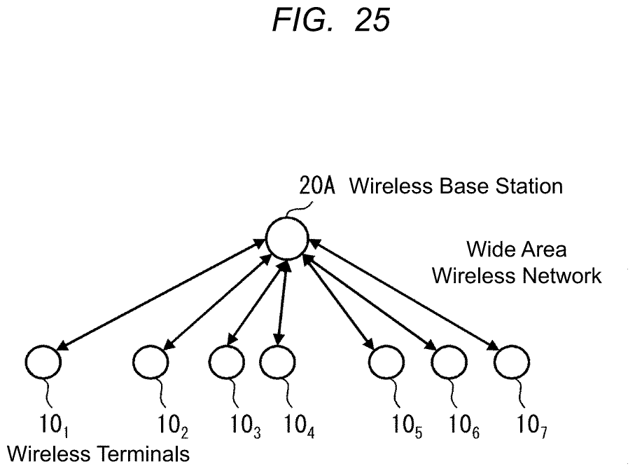

In the above embodiment, the wireless control device 30 is provided independently of the wireless base station 20, but the present invention is not limited thereto. For example, as shown in FIG. 25, instead of the wireless base station 20, a wireless base station 20A incorporating the function of the wireless control device 30 may be provided, and the wireless control device 30 may be deleted. In this configuration, the wireless base station 20A performs the same operation as the operation performed by the wireless control device 30.

In the following embodiments, when it is necessary for convenience, the description will be made by dividing into a plurality of sections or embodiments, but except for the case where it is specifically specified, they are not independent of each other, and one of them is related to some or all of modifications, details, supplementary description, and the like of the other. In the following embodiments, the number of elements or the like (including the number, number, quantity, range, and the like) is not limited to the specific number except the case where it is specified in particular or the case where it is obviously limited to the specific number in principle, and may be a specific number or more or less.

Furthermore, in the following embodiments, it is needless to say that the constituent elements (including element steps and the like) are not necessarily essential except in the case where they are specifically specified and the case where they are considered to be obviously essential in principle. Similarly, in the following embodiments, when referring to the shapes, positional relationships, and the like of components and the like, it is assumed that the shapes and the like are substantially approximate to or similar to the shapes and the like, except for the case in which they are specifically specified and the case in which they are considered to be obvious in principle, and the like. The same applies to the above numerical values and ranges.

The circuit elements constituting the functional blocks of the embodiment are not particularly limited, but are formed on a semiconductor substrate such as a single-crystal silicon substrate by an integrated circuit technique such as a well-known complementary MOS transistor (CMOS).

Hereinafter, embodiments of the present invention will be described in detail with reference to the drawings. In all the drawings for explaining the embodiments, the same members are denoted by the same reference numerals in principle, and repetitive descriptions thereof are omitted.

### Embodiment 1

(Outline of Signal Processing Device)

FIG. 1 is a block diagram showing a schematic configuration example of a signal processing device according to Embodiment 1 of the present invention. The signal processing device SYSa shown in FIG. 1 includes an oscillator circuit VCO, a circuit under test DUT, and a clock control circuit CKCTL. The oscillation circuit VCO receives the frequency control signal Vcs and generates a clock signal CLK having a frequency corresponding to the frequency control signal Vcs. The circuit-under-test DUT includes a circuit-under-protection PRC and a delay-time detecting circuit DLYDET.

The protection target circuit PRC operates based on the clock signal CLK, and includes, for example, a latch circuit LT that performs a latch operation in synchronization with the clock signal CLK, various combination circuits (not shown), and the like. Specifically, the protective circuit PRC is a microcomputer (MCU (Micro Controller Unit)) having a logic circuit and an analogue circuit, a CPU (Central Processing unit), various control logic circuits, or the like.

The delay time detecting circuit DLYDET detects a delay time of signals generated in a predetermined group of circuit elements in the protective circuit PRC. Specifically, the delay time detection circuit DLYDET includes a test circuit element group reflecting the configuration of a predetermined circuit element group in the protection-target circuit PRC, and outputs a delay detection signal Q reflecting the delay time by detecting a delay time of a signal generated in the test circuit element group. The delay amount detection signal Q is, for example, an analog signal having a pulse width reflecting a delay time. Here, at least the protection-target circuit PRC and the delay-time detecting circuit DLYDET are mounted on the same semiconductor chip. The delay detecting circuit DLYDET is provided, for example, inside the protection target circuit PRC or in the vicinity of the protection target circuit PRC.

The clock control circuit CKCTL is provided outside the protection-target circuit PRC, and receives the delay detection signal Q to generate a frequency control signal Vcs for decreasing the frequency of the clock signal CLK in accordance with an increase in the delay time. In this embodiment, the clock-control circuit CKCTL includes a delay-amount-voltage converter circuit DVC and a frequency-control circuit FCTL. The delay amount voltage converter DVC converts the delay amount detection signal Q into a delay amount detection voltage Vcnt having a voltage value corresponding to the pulse width of the delay amount detection signal Q. The frequency control circuit FCTL generates a frequency control signal Vcs for decreasing the frequency of the clock signal CLK in response to an increase in the delay time based on the delay amount detection voltage Vcnt. For example, the frequency control signal Vcs is an analog voltage, and the oscillation circuit VCO is a voltage controlled oscillator.

As described above, the signal processing device SYSa of FIG. 1 constitutes a feedback control device that controls the frequency of the clock signal CLK supplied to the protection target circuit RPC based on the delay time of the signal generated in the protection target circuit RPC, which is actually the delay time detecting circuit DLYDET. Specifically, the device lowers the frequency of the clock signal CLK in accordance with an increase in the delay time. Therefore, even when the delay time increases due to the aging deterioration, in other words, when the delay failure occurs, the protection target circuit PRC can continue the operation substantially equivalent to the normal operation without malfunctioning.

The oscillator circuit VCO, the circuit under test DUT, and the clock control circuit CKCTL shown in FIG. 1 are formed of, for example, one semiconductor chip (semiconductor device) in order to enable miniaturization and mass production of the signal processing device SYSa. However, the present invention is not limited thereto, and a signal processing device may be configured by a plurality of semiconductor chips.

(Details of the Delay Time Detection Circuit)

FIG. 2 is a circuit diagram showing a configuration example of a delay time detection circuit in the signal processing device of FIG. 1. FIG. 3 is a timing chart showing an operation example of the delay time detection circuit of FIG. 2. The delay detecting circuit DLYDET of FIG. 2 includes a logic operation circuit EOR, a delay generating circuit DLYG, and two buffers BF1,BF2. The delay generator DLYG generates the delayed clock signal CKd by delaying the clock signal CLK inputted through the buffers BF1.

The logic operation circuit EOR performs a logic operation (EXOR operation) using the clock signal CKr and the delayed clock signal CKd input through the buffer BF2 as input, thereby detecting a time difference between the clock signal CKr and the delayed clock signal CKd. Then, as shown in FIG. 3, the logic operation circuit EOR outputs, as the delay amount detection signal Q, a signal having a pulse width D based on the detected time difference at the same frequency (period T) as the clock signal CLK. In other words, the logic operation circuit EOR is a signal representing the ratio of the time difference (pulse width D) with respect to the cycle T of the clock signal as the delay amount detection signal Q, and outputs a signal having a duty ratio of “D/T”.

Here, the delay generation circuit DLYG is composed of a test circuit element group in which the configuration of a predetermined circuit element group in the protection-target circuit PRC is reflected. The inspection circuit element group (predetermined circuit element group in the protection target circuit PRC) is a circuit group in which an increase in delay time due to aging is predicted, and is determined in advance as an observation target by a designer or the like. The test circuit element group is arranged in the protection target circuit PRC or in the vicinity of the protection target circuit PRC so as to faithfully reproduce the degree of deterioration of a predetermined circuit element group in the protection target circuit PRC. Here, as an example, the test circuit element group includes a plurality of stages of inverter circuits IV. However, the test circuit element group is not limited to this, and the test circuit element group may have a configuration in which various logic operation circuits such as inverters, NAND operation circuits, NOR operation circuits, and the like are combined as appropriate and directly connected to each other. FIG. 3 shows the delayed clock signal CKd1 when the aging deterioration does not occur and the delayed clock signal CKd2 when the delay time increases with the aging deterioration. The pulse width D2 of the delay amount detection signal Q2 obtained by the delay clock signal CKd2 is larger than the pulse width D1 of the delay amount detection signal Q1 obtained by the delay clock signal CKd1. As described above, as the aging deterioration progresses, the duty ratio of the delay amount detection signal Q increases.

(Details of the Delay Voltage Conversion Circuit)

FIG. 4 is a circuit diagram showing a configuration example of a delay amount voltage conversion circuit in the signal processing device of FIG. 1. The delay amount voltage converter circuit DVC shown in FIG. 4 is an active low-pass filter circuit that averages the delay amount detection signals Q from the delay time detection circuit DLYDET. Specifically, the delay amount voltage converter circuit DVC includes an integrating circuit having a negative feedback configuration including an operational amplifier AMP1, an input resistor R0, a feedback capacitor C0, and a variable voltage source VGm, and a feedback resistor Rf1. The variable voltage source VGm generates a voltage Vm with reference to the ground power supply voltage GND. The operational amplifiers AMP1 are supplied with power supply voltages AVDD.

An input current corresponding to the difference between the voltage of the delay amount detection signal Q and the voltage Vm flows through the input resistor R0. The input current flows through the feedback resistor Rf1 and is accumulated in the feedback capacitor C0. When the steady-state is reached, generally, the average current of the input current flows through the feedback resistor Rf1, and the difference current between the input current and the average current is charged and discharged by the feedback capacitor C0. Therefore, as the duty ratio of the delay amount detection signal Q increases, the mean current increases, and the delay amount detection voltage Vcnt decreases via the feedback resistor Rf1. The level of the mean current and thus the level of the delay detection voltage Vcnt are also controlled by the voltage Vm.

FIG. 5 is a waveform diagram showing an operation example of the integration circuit in the delay amount voltage conversion circuit of FIG. 4. As shown in FIG. 5, when the delay amount detection signal Q is not inputted, the operational amplifier AMP1 outputs the offset voltage Voffset as the delay amount detection signal Vcnt. The offset voltage Voffset can be set by, for example, the offset voltage Vm. When the delay amount detection signal Q is inputted, the delay amount detection voltage Vcnt is lowered by the function of the integrating circuit in the “H” level period (period from time t1 to t2) of the pulse width D1 and the “H” level period (period from time t4 to t5) of the pulse width D2. On the other hand, in the “L” level period (the period from time t2 to t3 and the period from time t5 to t6), the delay detecting voltage Vcnt rises toward the offset voltage Voffset due to the function of the integrator. As a result, the mean voltage value of the delay detecting voltage Vcnt becomes “Vcnt1” in the period T (period from time t1 to t3) of the clock signal CLK including the pulse width D1, and becomes “Vcnt2” in the period T (period from time t4 to t6) of the clock signal CLK including the pulse width D2. Here, the pulse width D2 is larger than the pulse width D1. Therefore, “Vcnt2” is lower than “Vcnt1”.

FIG. 6 is a diagram showing an example of the relationship between the deterioration delay time detected by the delay time detection circuit and the delay amount detection voltage in FIG. 1. In FIG. 6, the deterioration delay time “td0” is a delay time (for example, corresponding to the pulse width D1 in FIG. 3) when it is assumed that the delay due to the aging deterioration does not occur in the delay generation circuit DLYG in FIG. 2. Further, the deterioration delay time “td1” is a delay time (for example, corresponding to the pulse width D2 in FIG. 3) when a delay due to the aging deterioration occurs in the delay generation circuit DLYG. When the deterioration delay time increases from “td0” to “td1”, the delay detection voltage Vcnt decreases from “V1” to “V0” in accordance with the increase in the deterioration delay time.

Here, the frequency of the clock signal CLK is controlled so that the frequency of the clock signal CLK is proportional to the magnitude of the delay detecting voltage Vcnt. In the case of FIG. 6, the area exceeding the deterioration delay time “td0” is a deterioration relief area in which the frequency of the clock signal CLK is reduced in accordance with the detection delay voltage Vcnt to thereby perform relief. On the other hand, a area in which the deterioration delay time “td0” is not reached is a normal area in which the deterioration delay time is operated at a constant frequency.

FIG. 6 shows the threshold delay voltages Vlmt determined on the basis of the frequencies of the clock signals CLK. The threshold delay voltage Vlmt is a voltage corresponding to the maximum clock frequency at which the protective circuits PRCs can operate for the respective deterioration delay times. As shown in FIG. 6, the characteristics of the delay amount detecting voltage Vcnt are determined so as to be lower than the threshold delay amount voltage Vlmt by the relief marginal voltage ΔV. In other words, the frequency of the clock signal CLK actually generated is determined to be lower than the maximum clock frequency by a frequency corresponding to the relief margin voltage ΔV.

More specifically, the relief margin voltage ΔV is set to a minimum necessary level so that the signal processing device can stably operate even when the protection target circuit PRC has a variation in device temperature, a variation in power supply voltage, a manufacturing variation, and the like. The relief margin voltage ΔV can be adjusted by, for example, the voltage Vm from the variable voltage source VGm in FIG. 4. However, in some cases, the variable voltage source VGm of FIG. 4 may be a fixed voltage source in which an optimal output voltage is set in advance. The relief margin voltage ΔV may be set by a level shift circuit LS (see FIG. 8) in a frequency control circuit FCTL (to be described later).

Further, the delay amount voltage conversion circuit DVC may have any function as long as it has a function of converting the magnitude of the pulse width of the delay amount detection signal Q into a DC voltage value, and is not particularly limited to the configuration example of FIG. 4, and can be realized by various circuits including, for example, a circuit as shown in FIG. 7. FIG. 7 is a circuit diagram showing another configuration example of the delay amount voltage conversion circuit in the signal processing device of FIG. 1. The delay amount voltage converter circuit DVCb shown in FIG. 7 is a passive low-pass filter circuit that averages the delay amount detection signals Q from the delay time detection circuit DLYDET by the resistor Rs and the capacitor C1.

(Details of the Frequency Control Circuit)

FIG. 8 is a circuit diagram showing a configuration example of a frequency control circuit in the signal processing device of FIG. 1. The frequency control circuit FCTL shown in FIG. 8 includes a gain adjusting circuit VGA and a level shifting circuit LS. The gain adjusting circuit VGA is, for example, an inverting amplifier including a resistor R1, a feedback resistor R2, and an operational amplifier AMP2. The operational amplifiers AMP2 are supplied with power supply voltages ΔVDD. The gain adjusting circuit VGA inverts and amplifies the delay amount detecting voltage Vcnt from the delay amount voltage converting circuit DVC with the gain G (=−r2/r1) by setting the resistance values of the resistors R1 and R2 to r1 and r2. In this example, the gain G is variably controlled by making the feedback resistor R2 a variable resistor. However, a fixed resistor determined in advance so as to achieve an optimum gain may be used.

The level shift circuit LS is, for example, a differential amplifier including resistors R3 to R5, a feedback resistor R6, an operational amplifier AMP3, and a variable voltage source VGr. The operational amplifiers AMP3 are supplied with power supply voltages ΔVDD. The variable voltage source VGr generates a voltage Vcoref reference on the ground power supply voltage GND. The level shifting circuit LS adjusts the bias level of the output voltage G×Vcnt of the gain adjusting circuit VGA to generate the frequency control signal Vcs. Specifically, for example, when the resistors R3 to R6 are set to the same resistance values, the differential amplifier outputs “Vcoref−(G×Vcnt)”. That is, the differential amplifiers invert the output voltage (G×Vcnt) of the gain adjuster VGA and level-shift the inverted output voltage by the voltage Vcoref to generate the frequency control signal Vcs. The variable voltage source VGr may be a fixed voltage source in which an optimum output voltage is set in advance.

FIG. 9 is a diagram showing an example of the relationship between the delay amount detection voltage and the frequency control signal in the frequency control circuit of FIG. 8. As shown in FIG. 9, when the delay detecting voltage Vcnt decreases from “V1” to “V0” in accordance with an increase in the delay time, the frequency control signal Vcs (here, the DC voltage) also decreases from “V11” to “V10” in accordance with the decrease in the delay time. As shown in FIG. 8, the delay detection voltage Vcnt is transmitted through the negative input terminals (−) of the two operational amplifiers AMP2,AMP3. Therefore, the delay detection voltage Vcnt and the frequency control signal Vcs are directly proportional to each other. In FIG. 9, the sensitivity of the frequency control signal Vcs to the delay detection voltage Vcnt is adjusted by the gain adjusting circuit VGA. The voltage range of the frequency control signal Vcs is adjusted by the level shift circuit LS.

The frequency control circuit FCTL is not limited to the configuration of FIG. 8, and can be applied to the gain adjusting circuit VGA as long as the delay detecting voltage Vcnt can be amplified, and can be applied to the level shifting circuit LS as long as the bias level of the frequency control signal Vcs can be adjusted. For example, as the gain adjustment circuit VGA, a non-inverting amplifier or the like may be used instead of the inverting amplifier. As the level shift circuit LS, a transistor circuit of a source follower or the like may be used.

(Details of the Oscillator Circuit)

FIG. 10 is a circuit diagram showing a configuration example of an oscillation circuit in the signal processing device of FIG. 1. FIG. 11 is a circuit diagram showing another configuration example of the oscillation circuit in the signal processing device of FIG. 1. The oscillator VCOa,VCOb shown in FIGS. 10 and 11 is a voltage-controlled oscillator. The oscillator circuit VCOa of FIG. 10 includes a plurality of cascaded inverter circuits IV1-IV3, a resistor R10 and a variable capacitor Cv for delaying the clock signal CLK outputted from the inverter circuit IV3 of the last stage and feeding the delayed clock signal CLK back to the inverter circuit IV1 of the first stage. The power supply voltage VDD from the voltage source VS is supplied to the plurality of stages of inverter circuits IV1-IV3.

The capacitance value of the variable capacitor Cv is controlled by the frequency control signal Vcs. As a result, the delay time of the signal inputted from the inverter circuit IV3 of the last stage to the inverter circuit IV1 of the first stage changes, and the frequency of the clock signal CLK can be changed. Specifically, for example, when the delay time detected by the delay time detecting circuit DLYDET increases, the voltage level of the frequency control signal Vcs decreases. In response to this, the capacitance of the variable capacitance Cv increases, and the delay time of the signal transmitted from the inverter circuit IV3 to the inverter circuit IV1 increases, so that the frequency of the clock signal CLK decreases.

On the other hand, the oscillator VCOb shown in FIG. 11 includes a fixed capacitor C10 instead of the variable capacitor Cv in FIG. 10, and includes a variable voltage source VVS instead of the voltage source VS. The power supply voltage VDD from the variable voltage source VVS is controlled by the frequency control signal Vcs. Since the delay time of the signal in the inverter circuit IV1-IV3 depends on the power supply voltage VDD, the frequency of the clock signal CLK can be changed by controlling the power supply voltage VDD. Specifically, for example, when the delay time detected by the delay time detecting circuit DLYDET increases, the voltage level of the frequency control signal Vcs decreases. In response to this, when the variable voltage source VVS lowers the power supply voltage VDD, the delay times of the signals in the respective inverter circuits IV1-IV3 increase, so that the frequency of the clock signal CLK decreases.

FIG. 12 is a diagram showing an example of the frequency characteristic of the clock signal with respect to the deterioration delay time detected by the delay time detection circuit in FIG. 1. As shown in FIG. 6, when the deterioration delay time detected by the protective circuit PRC (actually, the delay time detection circuit DLYDET) increases from “td0” to “td1”, the delay detection voltage Vcnt decreases from “V1” to “V0”. When the delay detecting voltage Vcnt decreases from “V1” to “V0”, the voltage level of the frequency control signal Vcs decreases from “V11” to “V10” as shown in FIG. 9.

That is, when the deterioration delay time detected by the protected circuit PRC increases from “td0” to “td1”, the voltage level of the frequency control signal Vcs decreases from “V11” to “V10”. As a result, as shown in FIG. 12, the frequency fclk of the clock signal CLK decreases from “f1” to “f0” in accordance with the decrease of the voltage level of the clock signal CLK from “V11” to “V10” of the voltage level of the frequency control signal Vcs.

As described above, when the signal processing device according to the first embodiment is used, the frequency fclk of the clock signal CLK can be automatically decreased in accordance with an increase in the delay time detected by the protection target circuit PRC. As a result, in the protection target circuit PRC, even when the delay time increases with the aging deterioration, in other words, when the delay failure occurs, it is possible to prevent the malfunction.

In the product of FIG. 12, as described in FIG. 6, the clock signal CLK is set to a predetermined frequency f1 (fspec) based on the normal specifications of the clock signal CLK, for example, in the area where the deterioration delay time is smaller than “td0”. On the other hand, when the deterioration delay time increases beyond “td0”, the frequency fclk of the clock signal CLK continuously decreases as the deterioration delay time increases. When the deterioration delay time further increases and reaches “td1”, the signal processing device determines that the product life of the circuit-to-be-protected PRC has been reached, and the signal processing device stops generating the clock signal CLK. As described above, the area in which the deterioration delay time is “td0”˜“td1” is a deterioration relief area for preventing a malfunction and ensuring, for example, the safety of the device, instead of lowering the throughput of the device.

(Modifications of the Signal Processing Device)

As described above, although the signal processing device SYSa of FIG. 1 is composed of an analogue circuit in this embodiment, part or all of the signal processing device can be replaced by a digital circuit. For example, a Digitally Controlled Oscillator may be used as the oscillator circuit VCO instead of the voltage-controlled oscillator, and the frequency control circuit FCTL may be configured as a digital circuit. In this instance, the frequency control circuit FCTL converts, for example, the output voltage of the delay voltage converter circuit DVC into a digital signal by an analog-to-digital converter, and outputs the frequency control signal Vcs as a digital signal by performing various arithmetic processes. The DCO generates a clock signal CLK having a frequency corresponding to the digital signal. In some cases, the delay amount voltage conversion circuit DVC may be configured by a digital filter or the like, and the delay amount detection signal Q may be a digital signal representing the value of the duty ratio.

When such digital circuits are used, for example, the relationship between the deterioration delay times and the frequency fclk of the clock signal CLK shown in FIG. 12 becomes discrete in accordance with the resolution of the analog-to-digital converter, the resolution of the clock signal CLK, and the like. Therefore, although a digital circuit can be used, from the viewpoint of controlling the frequency fclk of the clock signal CLK with high resolution and seamlessly, it is more desirable to configure the signal processing device SYSa by an analogue circuit. Further, by using the analog circuit, the control delay can be reduced and the response speed can be increased as compared with the case of using the digital circuit.

(Control Flow of Signal Processing Device)

FIG. 13 is a flowchart showing an example of a control procedure in the control method of the signal processing device according to the first embodiment of the present invention. In FIG. 13, first, in operation S1, the oscillator VCO generates a clock signal CLK having a frequency fclk corresponding to the frequency control signal Vcs. Next, the delay time detection circuit DLYDET detects a delay time of a signal generated in a predetermined group of circuit elements in the protection-target circuit RPC, and outputs a delay detection signal Q in operation S2.

In operation S3, the delay amount voltage converter DVC converts the delay amount detection signal Q into a delay amount detection voltage Vcnt having a voltage value corresponding to the pulse width D of the delay amount detection signal Q. Thereafter, the clock control circuit CKCTL generates a frequency control signal Vcs for decreasing the frequency of the clock signal CLK in accordance with the increase in the delay time based on the detection delay voltage Vcnt in operation S4.

(Outline of the Signal Processing Device (Comparative Example))

FIG. 21 is a block diagram showing a schematic configuration example of a signal processing device as a first comparative example of the present invention. The signal processing device SYS′a of the first comparative example includes a fault detecting unit ERRDU. The failure detection unit ERRDU includes an oscillator OSC, a plurality of delay generation circuits DLYG′1˜DLYG′3, selectors SEL, and a delay failure detection circuit DET. The fault detecting unit ERRDU detects the magnitude relation between the plurality of delay generating circuits (signal delay paths) DLYG′1˜DLYG′3 using the selectors SEL and the delay fault detecting circuits DET, and stores the detected relationships in the memories. Every time detection is performed, the failure detection unit ERRDU compares the detection result with the magnitude relation stored in the memories, thereby detecting aging deterioration in a plurality of signal delay paths.

As described above, if the failure detecting unit ERRDU is provided in the signal-processing-device SYS′a, the aging deterioration can be detected. However, simply providing the failure detecting unit ERRDU in the device does not necessarily prevent malfunction of the device and secure safety. That is, as described above, it is necessary to take other measures such as duplexing the device and requesting the user to replace the components at an early stage in response to the detection of aging deterioration. As a result, there arise problems such as an increase in cost and shortening of product life due to ensure an excessive margin. Further, in the case of component replacement, it is not always possible to prevent malfunction of the device until replacement is performed, and it is not always possible to secure safety or the like.

FIG. 22 is a block diagram showing a schematic configuration example of a signal processing device as a second comparative example of the present invention. The signal-processing-device SYS′b shown in FIG. 22 includes CPUs, setting tables TBL stored in advance in memories, and PLLs (Phase Locked Loop). The PLL supplies a clock signal CLK to the CPU. The CPUs include, for example, a failure detecting unit ERRDU as shown in FIG. 21. The setting table TBL determines the relationship between the delay time td and the frequency fclk of the clock signal CLK. The CPU acquires the frequency fclk by referring to the setting table TBL based on the delay time td detected by the failure detecting unit ERRDU. Then, the CPU instructs the PLL to perform the frequency fclk, and in response to this, the CPU changes the frequency of the clock signal CLK.

For example, by using such a signal processing device, the same control as that of the signal processing device SYSa of the first embodiment can be performed. However, in the method as shown in FIG. 22, the CPU changes the frequency of its own clock signal CLK at its own judgment based on the detection result of the delay time. In this case, the processing load of the CPU becomes large. On the other hand, in the method of the first embodiment, as shown in FIG. 1, a control loop is provided outside the protection target circuit PRC, which corresponds to the CPU of FIG. 22, and the frequency of the clock signal CLK can be controlled without going through the processing of the protection target circuit PRC. As a result, an increase in the processing load of the protection target circuit PRC can be prevented.

Further, in the method as shown in FIG. 22, although the frequency is controlled according to the detection result of the delay time, the frequency after the modification is not verified in some manner. That is, unlike a closed loop control device in which the state is changed by the control and further control is performed by detecting the change in the state, the device of FIG. 22 is substantially an open loop control device in which the control is terminated by changing the frequency. In this case, the accuracy in controlling the frequency depends on the circuit configuration, the process structure, and the like of the oscillation circuit.

On the other hand, in the method of the first embodiment, the delay time detection circuit DLYDET outputs a signal representing the ratio of the pulse width (time difference) D to the cycle T of the clock signal CLK as the delay amount detection signal Q, as shown in FIG. 3, and the clock control circuit CKCTL controls the frequency of the clock signal CLK based on the delay amount detection signal Q. That is, the delay-time detecting circuit DLYDET can operate by receiving, for example, a pulse signal different from the clock signal CLK, but in this case, the delay-time detecting circuit DLYDET operates by receiving the same clock signal CLK as that of the protection-target circuit RPC. As a result, since the actual frequency (period T) of the clock signal CLK is substantially detected and then the control reflecting the detected frequency (period T) is performed, the frequency (period T) of the clock signal CLK can be controlled with high accuracy regardless of the circuit configuration, the process structure, or the like of the oscillation circuit.

As a specific operation example, for example, as shown in FIG. 3, when the pulse width (time difference) D increases, the duty ratio of the delay amount detection signal Q increases, and the delay amount detection voltage Vcnt decreases based on the gain of the delay amount voltage converter circuit (low-pass filter circuit) DVC in FIG. 4. When the delay detection voltage Vcnt decreases, the clock signal CLK is controlled so that the cycle T of the clock signal CLK extends based on the gain G of the frequency control circuit FCTL of FIG. 8. When the period T increases, the duty ratio of the delay amount detection signal Q decreases, and the delay amount detection voltage Vcnt increases based on the gain of the delay amount voltage converter DVC. When the delay detection voltage Vcnt rises, the delay detection voltage Vcnt is controlled to shorten the period T based on the gain G of the frequency control circuit FCTL.

Thereafter, an operation is repeated in which the delay amount voltage conversion circuit DVC lowers the delay amount detection voltage Vcnt in accordance with the shortening of the period T, the frequency control circuit FCTL extends the period T in response thereto, the delay amount voltage conversion circuit DVC raises the delay amount detection voltage Vcnt in response thereto, and the frequency control circuit FCTL shortens the period T in response thereto. At this time, if the gain of the delay amount voltage converter circuit DVC and the gain G of the frequency control circuit FCTL are appropriately determined, the amounts of change in the delay amount detected voltage Vcnt and the period T are successively reduced in the repetitive process, and the period T (frequency) of the clock signal CLK can be converged to predetermined values.

(Comparison of Product Lifetime Between the Method of Embodiment 1 and the Method of the First Comparative Example)

FIG. 14 is a conceptual diagram comparing product lifetimes of the signal processing device of FIG. 1 and the signal processing device of FIG. 21. The upper frame of FIG. 14 shows the original product life until a delay failure occurs and the product becomes inoperable. The middle frame of FIG. 14 shows the lifetime of products when the signal-processing device SYS′a of FIG. 21 is used. In the method of the comparative example, it is necessary to detect a delay fault after a sufficient fault detection margin ΔT1 is secured before the operation is disabled. The failure detection margin ΔT1 becomes large particularly when the user is requested to replace the components at an early stage as described with reference to FIG. 21. As a result, the product life is excessively short compared to the original product life.

The lower frame of FIG. 14 shows the lifetime of products when the signal-processing-device SYSa of FIG. 1 is used. In the signal processor SYSa of FIG. 1, the frequency fclk of the clock signal CLK is automatically adjusted while the minimum relief margin ΔT2 corresponding to the relief margin voltage ΔV of FIG. 6 is secured in accordance with the increase in the delay time td of the protective circuit PRC. The remedy margin ΔT2, for performing remedies by automatically adjusting the frequency fclk, may be less than the fault detection margin ΔT1 in the method of at least the comparative example.

The lower frame of FIG. 14 shows the case of continuously automatically adjusting the frequency fclk in accordance with the delay time td and the case of automatically adjusting the frequency in a stepwise manner. The case of the stepwise automatic adjustment corresponds to the case where part or all of the signal processing device is configured by a digital circuit as described above. Here, in order to facilitate understanding, description will be made on the assumption that automatic adjustment is performed stepwise. First, immediately after the product starts to be used (i.e., in a state in which a delay failure has not occurred), the signal-processing-device SYSa sets the frequency fclk to the first frequency fclk[1]. Thereafter, when the delay time td reaches the first reference time d1, the signal-processing-device SYSa automatically adjusts the frequency fclk, thereby starting the remedy. The reference quantity d1 corresponds to, for example, the deterioration delay time “td0” in FIG. 12.

When the delay time td reaches the first reference value D1, the signal-processing-device SYSa lowers the frequency fclk to a second frequency fclk[2] lower than the first frequency fclk[1]. Thereafter, when the delay time td reaches the second reference amount d2 which is larger than the first reference amount d1, the signal-processing-device SYSa lowers the frequency fclk to the third frequency fclk[3] which is lower than the second frequency fclk[2]. Thereafter, in the same manner, the automatic frequency adjustment is performed toward the lower limit frequency at which the reduction of the processing capacity is allowed, and the automatic frequency adjustment is finished when the relief margin ΔT2 is added to the lower limit frequency.

Here, for example, when the protection target circuit RPC operates at the second frequency fclk [2], even if the delay time td between the reference amounts d1 to d2 occurs, the malfunction of the protection target circuit RPC does not occur. That is, the reference amounts d1 and d2 are preset to values having a minimum margin with respect to the delay time td which causes a malfunction when the protected circuit RPC is operated at the second frequency fclk [2].

For example, if the delay time immediately after the start of use in the protective circuit RPC is “td[0]” and the time of 1% of the cycle T of the clock signal CLK corresponding to the first frequency fclk[1] is “Δtc[1]”, the reference quantity d1 is determined to be, for example, “td[0]+Δtc[1]” or the like. Similarly, when the period T of the clock signal CLK corresponding to the second frequency fclk[2] is 1% of the period T of the clock signal CLK, the reference quantity d2 is determined to be, for example, “d1+Δtc[2]” or the like. In this case, the relief margin ΔT2 in FIG. 14 becomes sufficiently large, and the margin against the malfunction can be sufficiently secured.

The reference amounts d1 and d2 may be determined to be 10% of the time instead of 1% of the time of the cycle T of the clock signal CLK. In this case, although the margin for the malfunction is small, the protection target circuit RPC can be operated at a higher frequency, and thus, a decrease in the processing capacity can be suppressed. In addition, the frequency of switching the frequency of the clock signal CLK can be reduced, and the operation of the signal processing device can be stabilized.

(Effects of Embodiment 1)

As described above, by using the signal processing device of the first embodiment, it is possible to prevent a malfunction, typically, even when a delay failure due to aging occurs. In addition, when the signal processing device is applied to a device requiring safety such as an automobile or the like, it is possible to maintain safety substantially equivalent to that at the time of normal operation. That is, although the processing capability is lowered by lowering the frequency fclk of the clock signal CLK, it is possible to prevent malfunctions such as operation errors and logical runaway and to maintain security within a range in which the processing capability is allowed to be lowered. Further, as described in FIG. 22, such an effect can be obtained without increasing the processing load of the protection target circuit PRC.

Further, in another aspect, as described in FIG. 14, it is possible to effectively extend the life of the product. As a result, the cost can be reduced. This cost reduction effect can also be obtained because the duplexing of the device or the like becomes unnecessary.

Although the increase of the delay time with the aging has been described as a problem here, the increase of the delay time can also be caused by variations of various environmental parameters such as, for example, the power supply voltage and the ambient temperature. For example, if the power supply voltage varies, ±10% of the rated voltage, and if the ambient temperature Ta varies, Ta varies from −40° C. to 125° C. At the stage of device design and circuit design, it is usually necessary to take such variations into consideration to ensure a sufficient safety margin.

On the other hand, when the signal processing device of the first embodiment is used, even when the delay time is increased due to such a variation in the environmental parameter, the delay time can be reduced by decreasing the frequency fclk of the clock signal CLK. As a result, the safety margin required at the stage of device design and circuit design can be relaxed, and the design can be facilitated accordingly. Further, since the safety margin can be relaxed not only in the design stage but also in the manufacturing stage, the production yield of the signal processing device can be improved.

### Embodiment 2

(Operation of the Signal Processing Device (Embodiment 2))

FIG. 15 is a diagram showing an example of the frequency characteristic of the clock signal with respect to the deterioration delay time detected by the delay time detection circuit in the signal processing device according to the second embodiment of the present invention. The configuration of the signal processing device according to Embodiment 2 is the same as that of Embodiment 1. In the characteristic shown in FIG. 15, the normal area in FIG. 12 is replaced with an overclock area. In the over-clock domain, the clock control circuit CKCTL of FIG. 1 generates a frequency control signal Vcs for increasing the frequency fclk of the clock signal CLK in accordance with the reduction of the deterioration delay time.

That is, the frequency fclk of the clock signal CLK is set to a prescribed frequency f1 (fspec) based on the specifications of the product in the normal area of FIG. 12, but is set to a value exceeding the prescribed frequency f1 (fspec) in the overclock area of FIG. 15. The delay time of the protection target circuit PRC generally decreases when the power supply voltage increases, when the ambient temperature decreases, or the like. As the delay time decreases, the protective circuit PRC can operate at a higher speed. Therefore, in such cases, by increasing the frequency fclk of the clock signal CLK, the throughput of the protective circuit PRC can be improved.

### Embodiment 3

(Outline of the Signal Processing Device (Embodiment 3))

FIG. 16 is a block diagram showing a schematic configuration example of a signal processing device according to Embodiment 3 of the present invention. The signal processing device SYSb shown in FIG. 16 further includes a deterioration determination circuit JDG and a warning generation circuit ARM, which are different from the signal processing device SYSb shown in FIG. 1. When the delay time based on the delay detection signal Q of the delay time detection circuit DLYDET is larger than a predetermined reference value, the deterioration determination circuit JDG generates a deterioration detection signal INT indicating the deterioration of the device. In this embodiment, the deterioration determination circuit JDG recognizes the delay time based on the delay amount detected voltage Vcnt from the delay amount voltage converter circuit DVC. The warning generation circuit ARM outputs a warning signal to the outside of the device in response to the deterioration detection signal INT.

Specifically, the deterioration detecting signals INT are generated in the deterioration relieving area (the area of the deterioration delay time td0˜td1) shown in FIG. 12. Thus, the deterioration detecting signal INT, it means that a state in which the life is prolonged by suppressing the frequency fclk of the clock signal CLK with deterioration. The signal-processing device SYSb of FIG. 15 is composed of one semiconductor chip, for example, in order to enable miniaturization of the signal-processing device and mass-production of the semiconductor chip. However, the signal processing device SYSb is not limited to this, and the signal processing device SYSb may be configured by a plurality of semiconductor chips.

(Details of the Deterioration Determination Circuit)

FIG. 17 is a circuit diagram showing a configuration example of a deterioration determination circuit in the signal processing device of FIG. 16. In this embodiment, the deterioration judging circuit JDG of FIG. 17 is an inverting amplifier including an operational amplifier AMP4, a resistor R11, a feedback resistor R12, and a variable voltage source VGcp. The variable voltage source VGcp generates a reference voltage Vcp. For example, by setting the gain to be large according to the ratio of the resistors R11 and R12, the inverting amplifiers function as comparator circuits that comparative and determine the magnitude relation between the reference voltage Vcp and the delay detecting voltage Vcnt. Here, the reference voltage Vcp can be appropriately variably set. For this reason, the deterioration determination circuit JDG can detect the degree of the deterioration delay time in a plurality of stages in the deterioration relief area of FIG. 12, for example.

The warning circuit ARM shown in FIG. 16 includes, for example, an external computer or an interface circuit for communicating with the host control device CSYS in the vehicle control device VHC described with reference to FIG. 19. The warning circuit ARM may include, for example, a circuit for lighting a warning lamp in response to the deterioration detection signal INT, a circuit for generating a warning sound, or the like. For example, when the driver of the vehicle hears the lighting of the warning lamp or the warning sound, it can be known that the signal processing device is deteriorated and the frequency of the clock signal CLK is lowered to prolong the life of the vehicle. Further, in some cases, the driver may request replacement of parts or the like at a step when the driver knows the life extending state.

(Control Flow of Signal Processing Device (Embodiment 3))

FIG. 18 is a flowchart showing an example of a control procedure in the control method of the signal processing device according to the third embodiment of the present invention. In the flow shown in FIG. 18, after the control of steps S1 to S3 shown in FIG. 13, the control of steps S6 and S7 is performed. In step S6, the deterioration determination circuit JDG compares the delay amount detection voltage Vcnt converted in step S3 with a predetermined reference voltage Vcp, and when the delay amount detection voltage Vcnt reaches the reference voltage Vcp, the deterioration determination circuit JDG generates a deterioration detection signal INT indicating deterioration of the device. Thereafter, in step S7, the warning circuit ARM outputs a warning signal to the outside in response to the deterioration detection signal INT.

(Configuration of Vehicle Control Device)

FIG. 19 is a block diagram showing a configuration example of a vehicle control device to which the signal processing device of FIG. 16 is applied. The vehicle control device VHC shown in FIG. 19 includes a host control device CSYS, a body device BD, a chassis device CHS, a powertrain device PWTR, an advanced automated driving device ADAS, and a human-machine interface HMI. The signal-processing device SYSb of FIG. 16 is applied to any device except for the upper control device CSYS, for example. In this instance, the upper control device CSYS receives warning signals from the warning circuits ARMs mounted on any one of the devices, and performs control such as, for example, adjusting the velocity of the entire device.

The signal-processing device SYSb of FIG. 16 may of course be applied to the upper control device CSYS, or may be applied to other devices (not shown) in the vehicle-control device VHC. Although the signal processing device SYSb shown in FIG. 16 is applied to the vehicle control device VHC here, the signal processing device SYSa shown in FIG. 1 may be applied to the vehicle control device VHC.

(Effects of Embodiment 3)

As described above, by using the signal processing device of Embodiment 3, in addition to the various effects described in Embodiments 1 and 2, it is possible to inform the host device and the user that the signal processing device is extending the life beyond the normal life. As a result, the host device can prevent the entire device from malfunctioning and enhance safety by, for example, performing an adjustment with another device. In addition, since the safety of the protection target circuit PRC is secured to some extent by the above-described deterioration relief, the user can request the replacement of parts or the like with sufficient time even when receiving the warning signal. Such an effect is particularly advantageous in the vehicle control device VHC as shown in FIG. 19.

### Embodiment 4

(Outline of the Signal Processing Device (Embodiment 4))

FIG. 20 is a block diagram showing a schematic configuration example of a signal processing device according to Embodiment 4 of the present invention. The signal processing device shown in FIG. 20 is a configuration example in which the implementation is limited to the configuration example in FIG. 16. In FIG. 20, the circuit-to-be-tested DUTs including the circuit-to-be-protected PRC and the delay-time detecting circuit DLYDET are mounted on the same semiconductor chip (semiconductor device DEVa). On the other hand, the oscillating circuit VCO, the clock control circuit CKCTL, the deterioration determination circuit JDG, and the warning circuit ARM, which are to be the rest of the oscillating circuit VCO, are mounted on the semiconductor device DEVb outside the semiconductor chip (semiconductor device DEVa). The semiconductor device DEVb is composed of, for example, one semiconductor chip.

The semiconductor device DEVa includes an external terminal PN1 to which the clock signal CLK is inputted and an external terminal PN2 to which the delay detecting signal Q is outputted. The semiconductor device DEVb includes an external terminal PN3 for outputting the clock signal CLK to the external terminal PN1 of the semiconductor device DEVa, and an external terminal PN4 for receiving the delay detecting signal Q from the external terminal PN2 of the semiconductor device DEVa.

(Effects of Embodiment 4)

As described above, when the signal processing device of Embodiment 4 is used, in addition to the various effects described in Embodiments 1 to 3 being obtained, it is possible to effectively utilize the existing apparatus to improve the versatility of the device. That is, the semiconductor device DEVa may be any of various conventional semiconductor devices as long as the semiconductor device has the same function as that of the delay detecting circuit DLYDET. By adding the semiconductor device DEVb to the conventional semiconductor device, various methods described in Embodiments 1 to 3 can be realized.

Although the invention made by the present inventor has been specifically described based on the embodiment, the present invention is not limited to the embodiment described above, and various modifications can be made without departing from the gist thereof. For example, the above-described embodiments have been described in detail in order to easily understand the present invention, and are not necessarily limited to those having all the configurations described. In addition, a part of the configuration of one embodiment can be replaced with the configuration of another embodiment, and the configuration of another embodiment can be added to the configuration of one embodiment. It is also possible to add, delete, or replace some of the configurations of the respective embodiments.

What is claimed is:

1. A wireless communication system comprising:
a wireless base station;
a plurality of wireless terminals each of which is driven by a battery;
a wireless control device configured to control a communication between the wireless base station and the wireless terminals;
wherein the wireless base station and the wireless terminals are configured to communicate by a first communication function or a second communication function, a power consumption of the second communication function being lower than that of the first communication function,
wherein the wireless control device determines, from the wireless terminals, a first wireless terminal whose remaining battery capacity is low and a second wireless terminal whose remaining battery capacity is higher than that of the first wireless terminal,
wherein the wireless control device controls a communication between the wireless base station and the second wireless terminal to be performed by the first communication function, and controls a communication between the first wireless terminal and the second wireless terminal to be performed by the second communication function.

2. The wireless communication system according to claim 1,
wherein the wireless control device controls a communication between the wireless base station and the first wireless terminal to be performed via the second wireless terminal.

3. The wireless communication system according to claim 2,
wherein the first wireless terminal transmits an uplink data to the second wireless terminal by the second communication function, and
wherein the second wireless terminal transmits the uplink data to the wireless base station by the first communication function.

4. The wireless communication system according to claim 3,
wherein the wireless base station transmits a downlink data to the second wireless terminal by the first communication function, and
wherein the second wireless terminal transmits the downlink data to the first wireless terminal by the first communication function.

5. The wireless communication system according to claim 1,
wherein each of the wireless terminals is configured to send own remaining battery capacity data to the base station.

6. The wireless communication system according to claim 1,
wherein the wireless control device is configured to redetermine the first wireless terminal and the second wireless terminal.

7. The wireless communication system according to claim 1,
wherein the wireless control device is further configured to determine a third wireless terminal which relays the communication between the first wireless terminal and the second wireless terminal.

8. The wireless communication system according to claim 7,
wherein the first wireless terminal transmits an uplink data to the second wireless terminal by the second communication function via the third wireless terminal, and
wherein the second wireless terminal transmits the uplink data to the wireless base station by the first communication function.

9. The wireless communication system according to claim 8,
wherein the wireless base station transmits a downlink data to the second wireless terminal by the first communication function, and
wherein the second wireless terminal transmits the downlink data to the first wireless terminal by the first communication function via the third wireless terminal.

10. A wireless communication system comprising:
a wireless base station;
a first wireless terminal driven by a first battery;
a second wireless terminal driven by a second battery;
wherein a remaining capacity of the first battery is lower than that of the second battery,
wherein a communication between the wireless base station and the second wireless terminal is performed by a first communication function,
wherein a communication between the first wireless terminal and the second wireless terminal is performed by a second communication function whose power consumption is lower than that of the first communication function,
wherein a communication between the wireless base station and the first wireless terminal is performed via the second wireless terminal.

11. The wireless communication system according to claim 10,
wherein the first wireless terminal transmits an uplink data to the second wireless terminal by the second communication function, and
wherein the second wireless terminal transmits the uplink data to the wireless base station by the first communication function.

12. The wireless communication system according to claim 11,
wherein the wireless base station transmits a downlink data to the second wireless terminal by the first communication function, and
wherein the second wireless terminal transmits the downlink data to the first wireless terminal by the first communication function.

13. The wireless communication system according to claim 10, further comprising a third wireless terminal which relays the communication between the first wireless terminal and the second wireless terminal.
